(19) United States
(12) Patent Application Publication
(10) Pub. No.: US 2018/0152767 A1
(43) Pub. Date: May 31, 2018

(54) PROVIDING RELATED OBJECTS DURING PLAYBACK OF VIDEO DATA

(71) Applicant: Alibaba Group Holding Limited, George Town (KY)

(72) Inventors: Simin Liu, Hangzhou (CN); Jingzhong Lian, Hangzhou (CN)

(21) Appl. No.: 15/823,088

(22) Filed: Nov. 27, 2017

(30) Foreign Application Priority Data
Nov. 30, 2016 (CN) 201611094976.5

(51) Int. Cl. H04N 21/81; H04N 21/435; H04N 21/431; H04N 21/218; H04N 21/478; H04N 21/4782; H04N 21/239; H04N 21/4722

(52) U.S. Cl. CPC H04N 21/8133; H04N 21/435; H04N 21/4316; H04N 21/4722; H04N 21/4781; H04N 21/4782; H04N 21/2393; H04N 21/21805

(57) ABSTRACT

Embodiments of the present application relate to a method, device, and system for processing playback of video data. The method includes obtaining an instruction during playback of video data, generating a request for data based at least in part on the instruction, wherein the request for data comprises information associated with the video data, communicating the request for data, obtaining results associated with the request for data, wherein the results associated with the request for data comprise one or more related objects relating to the video data, the one or more related objects corresponding to one or more respective application types, at least one of the one or more application types corresponding to at least one of the one or more related objects differing from an application type of the video data, and providing at least one of the one or more related objects concurrently with the video data.

### CROSS REFERENCE TO OTHER APPLICATIONS

This application claims priority to People's Republic of China Patent Application No. 201611094976.5 entitled A PLAY PROCESSING METHOD, MEANS AND DEVICE, filed Nov. 30, 2016, which is incorporated herein by reference for all purposes.

### FIELD OF THE INVENTION

The present application relates to a field of computer technology. In particular, the present application relates to a method, device, system, and operating system for video processing.

### BACKGROUND OF THE INVENTION

As terminal technology develops and televisions become further developed and integrated smart technology, users may use smart televisions to execute various necessary operations, such as watching videos, playing games, and browsing web pages.

A user may use a full screen of a smart television to view video. However, if a prompt message is generated and to be displayed during the viewing process, current technology often requires the currently played video to be exited in order for the user to view the message. The requirement of the currently played video to be discontinued to view a message affects normal playing of videos and can be a negative experience for a user. Moreover, if the user has a question concerning the video content, such a question usually cannot be answered by online searching during playback of the video unless the user pauses the video and performs a separate search.

### BRIEF DESCRIPTION OF THE DRAWINGS

Various embodiments of the invention are disclosed in the following detailed description and the accompanying drawings.

FIG. 1A is a diagram of an interface for displaying video according to various embodiments of the present application.

FIG. 1B is a diagram of an interface for displaying related objects according to various embodiments of the present application.

FIG. 2 is a flowchart of a method for video play processing on a terminal side according to various embodiments of the present application.

FIG. 3 is a diagram of an interface for displaying related objects according to various embodiments of the present application.

FIG. 4 is a flowchart of a method for play processing on a terminal side according to various embodiments of the present application.

FIG. 5 is a diagram of an interface for displaying multi-camera recommendation content according to various embodiments of the present application.

FIG. 6 is a diagram of an interface for displaying video-related pages according to various embodiments of the present application.

FIG. 7 is a flowchart of a method for play processing on a server side according to various embodiments of the present application.

FIG. 8 is a flowchart of a method for play processing on a server side according to various embodiments of the present application.

FIG. 9 is a structural diagram of an operating system according to various embodiments of the present application.

FIG. 10 is a functional diagram of a computer system for play processing according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

In an embodiment of the present application, a “smart terminal” is a terminal device having multimedia functions. A smart terminal supports audio, video, data, and other such functions. The smart terminal can have a touchscreen. The smart terminal can correspond to a smart mobile device such as a smart phone, a tablet computer, or a smart wearable device, or a smart television, personal computer, or other such device with a touchscreen. Various operating systems such as Android, iOS, YunOS, and tvOS can be implemented on the smart terminal. Various embodiments discussed herein are in the context of the example of a television device using tvOS; however, other types of terminals or operating systems can be used.

According to various embodiments, a terminal can display a prompt message during playback of a video. For example, the prompt message can be displayed on the display of the terminal while the terminal is displaying video data in a full screen format.

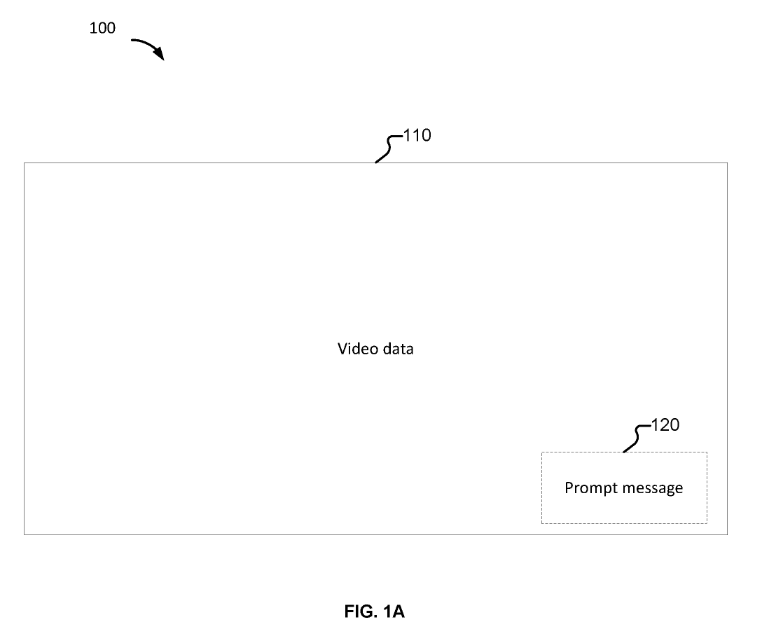

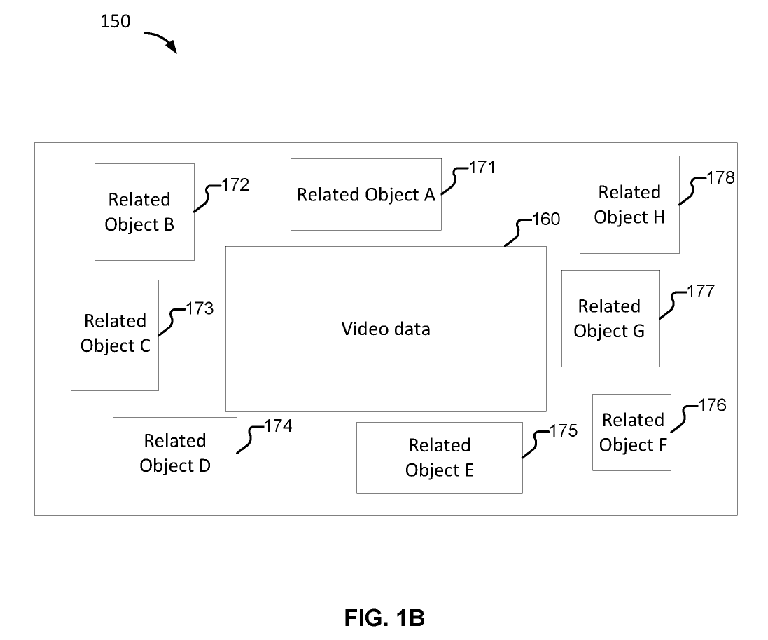

FIG. 1A is a diagram of an interface for displaying video according to various embodiments of the present application.

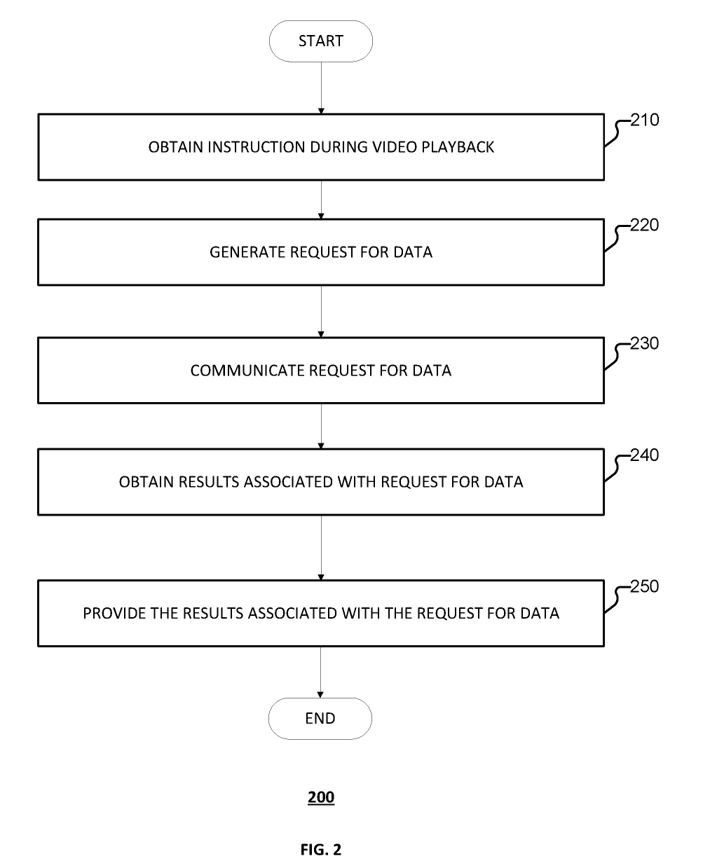

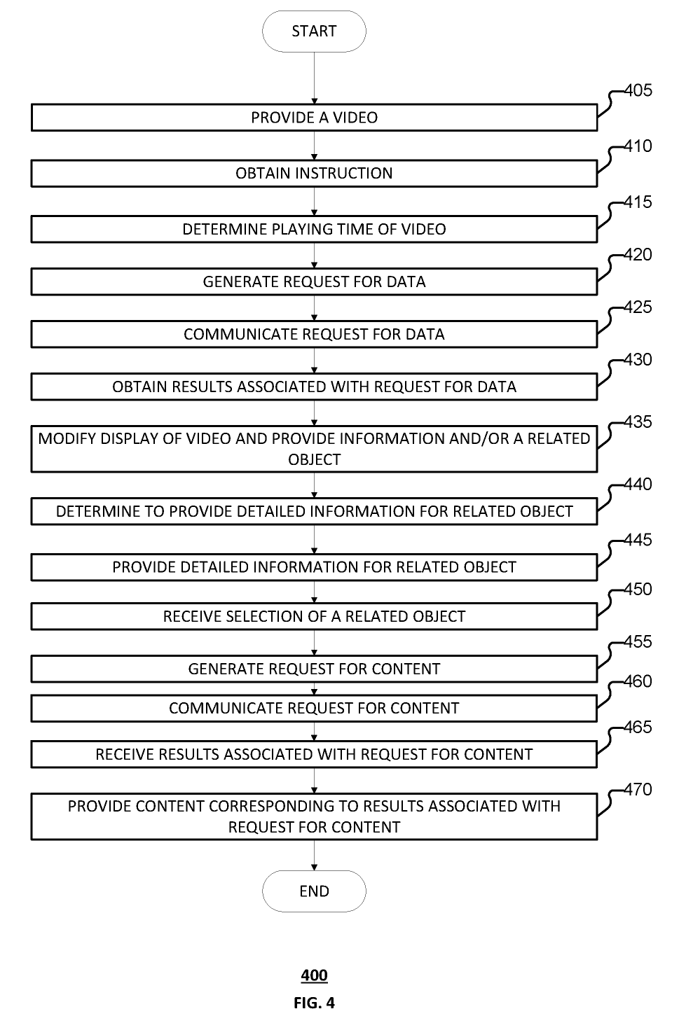

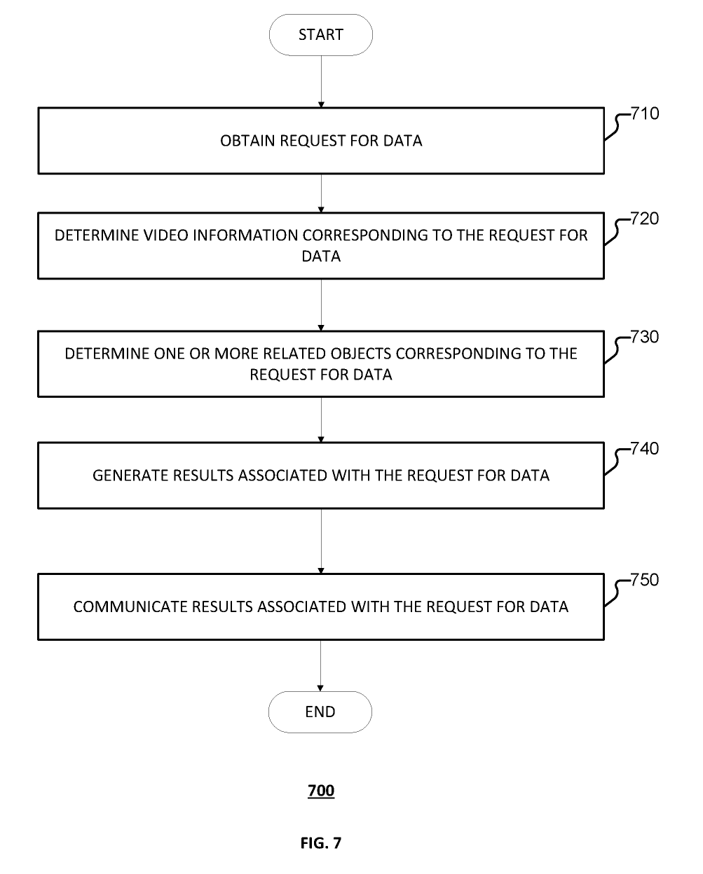

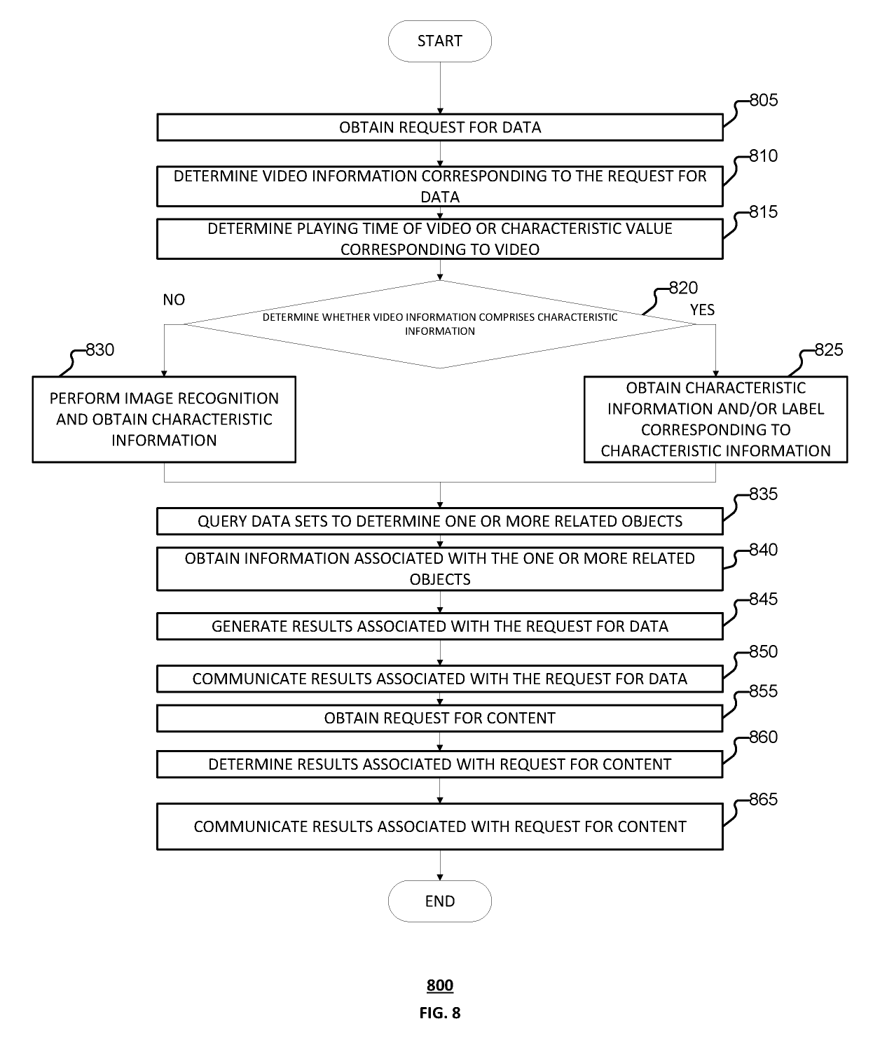

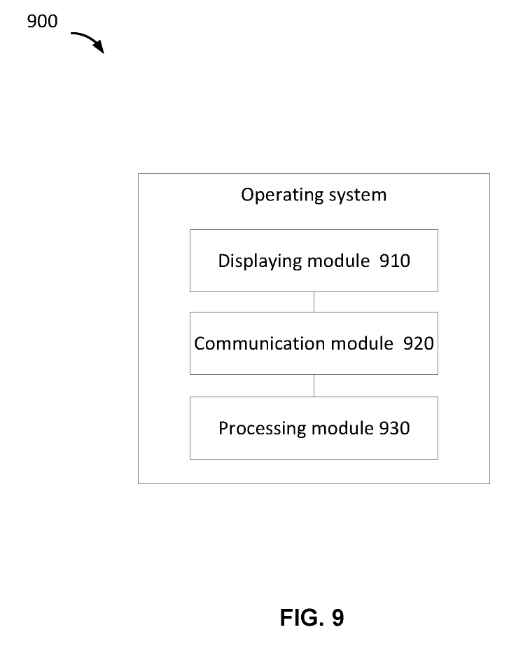

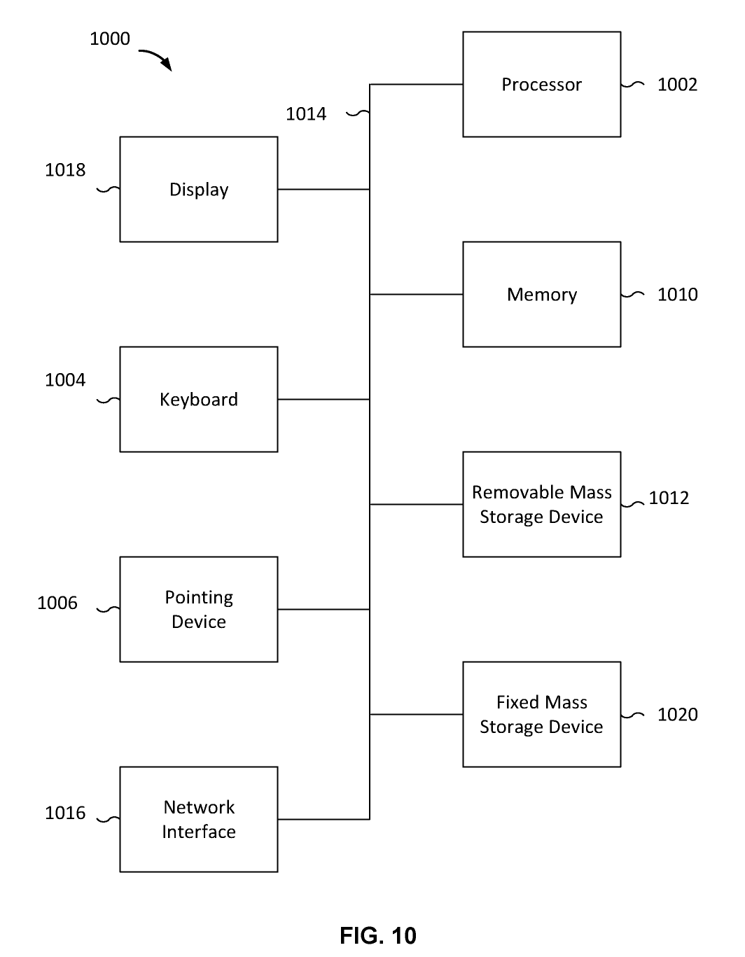

Referring to FIG. 1A, interface 100 is provided. Interface 100 can be implemented in connection with process 200 of FIG. 2, process 400 of FIG. 4, process 700 of FIG. 7, and/or process 800 of FIG. 8. Interface 100 can be implemented by operating system 900 of FIG. 9 and/or system 1000 of FIG. 10.

Interface 100 can be provided by the terminal to a user. Interface 100 can include video data 110 and a prompt message 120. Video data 110 can be provided in a full-screen format. The full-screen format can correspond to a format in which the video data is expanded or zoomed such that the video data is displayed over the entire screen of the terminal. The prompt message 120 is displayed while the video data 110 is being displayed on the terminal. For example, the prompt message 120 can be displayed to be overlaid with the video data 110. The prompt message can be displayed in various positions in relation to the screen.

The prompt message 120 can be displayed in response to a user's instruction or a preset event (e.g., the video data comprises a move star's face, a dress, a food item, or another element or item associated with a prompt message. For example, the prompt message 120 is displayed in response to an input by the user to the terminal. As another example, the prompt message 120 is displayed in response to the terminal determining that a particular portion of the video data 110 has associated therewith information relating to the prompt message. For example, the prompt message 120 can be associated with metadata that is obtained in connection with the video data 110. As another example, the prompt message 120 is displayed in response to the terminal receiving an instruction (or other information) from a server.

According to various embodiments, the prompt message 120 includes information that relates to the video data 110. For example, the prompt message 120 can include information that relates to content or context of the video 110 being contemporaneously displayed on interface 100.

In the context of the terminal corresponding to a smart television, the smart television can provide (e.g., display) video data 110 in full screen to a user. For example, the user can view video data 110 on the smart television in full screen. While the smart television is displaying the video data 110 in full screen, the smart television can display one or more prompt messages 120. For example, prompt message 120 can include “do you know who the star in the show is?”

FIG. 1A illustrates prompt message 120 being denoted by a dashed line. The dashed line indicates that a prompt message might or might not be displayed.

If the user wants to obtain information during playback of video data 110, the user can input a query. For example, while video data 110 is being displayed, if the user wants to know the star of a show, the plot, user comments, related merchandise, or other such information, the user can input (e.g., send) a user instruction. The user can input the user instruction via a touch screen of the terminal, via a control that is wirelessly connected to the terminal, via a voice input that is detected by the terminal, etc.

The smart television (e.g., the terminal) accordingly receives the user instruction. The terminal determines a part of the video data 110 associated with the user instruction. The terminal can determine the part of the video data 110 associated with the user instruction based on the user instruction or one or more characteristics of the user instruction (e.g., a time at which the user instruction is input). For example, the user instruction can serve as a basis for determining all or part of the video frame corresponding to the video data 110. For example, the terminal captures a video frame of the video data 110 that is to be associated with the user instruction. As another example, the terminal determines the playing time point to be captured based on the user instruction or one or more characteristics of the user instruction (e.g., a time at which the user instruction is input, a content of the user instruction such as a key word). The user instruction serves as a basis for generating a data acquisition request. For example, the terminal generates a data acquisition request based at least in part on the user instruction. The terminal can generate the data acquisition request based at last in part on the user instruction and the corresponding video data 110. In response to generating the data acquisition request, the terminal can communicate the data acquisition request to a server. For example, the data acquisition request is sent to a server via a network.

One or more queries are performed based at least in part on the data acquisition request. For example, the server can use the data acquisition request as a basis for queries concerning various related objects related to the video associated with video data 110 and the video frame and for acquiring related objects (e.g., an actor in the video data, a dress or item of clothing in the video data, a food item, etc.) and information relating to the characteristic information on the video data 110 (e.g., information on a page introducing a starring actor in a video frame, information on a merchandise page for apparel of the same style as the star in the video frame, information on a page introducing the corresponding plot, information on a page of user video evaluations of the video, etc.). In some embodiments, the one or more queries performed based at least in part on the data acquisition request include performing a web search. In some embodiments, the one or more queries performed based at least in part on the data acquisition request include querying one or more databases to which the server is connected.

In connection with performing the one or more queries, the server obtains one or more related objects that are responsive to the one or more queries. The related objects can be text, an image, a video, a hyperlink (e.g., to a web page or other resource), applications, content obtained from one or more applications, etc.

The server generates data acquisition results based on the related objects (e.g., an actor in the video data, a dress or item of clothing in the video data, a food item, etc.) and sends the data acquisition results to the terminal (e.g., the smart television).

The terminal (e.g., the smart television) receives the data acquisition results. The terminal can obtain related objects identified by the server (e.g., in the data acquisition results). As an example, the terminal acquires the related objects in connection with receiving the data acquisition results. So as not to affect normal viewing by the user, the terminal can switch the video data 110 to non-full screen mode and thus continue to play the video data within the interface. Moreover, it displays a related object presenting interface, wherein at least one of said at least two related objects can be displayed.

FIG. 1B is a diagram of an interface for displaying related objects according to various embodiments of the present application.

Referring to FIG. 1B, interface 150 is provided. Interface 150 can be implemented in connection with process 200 of FIG. 2, process 400 of FIG. 4, process 700 of FIG. 7, and/or process 800 of FIG. 8. Interface 150 can be implemented by operating system 900 of FIG. 9 and/or system 1000 of FIG. 10.

According to various embodiments, interface 150 can be provided (e.g., displayed) by the terminal in connection with interface 100 of FIG. 1B. For example, if a query is input to interface 100, interface 150 is displayed in response to an obtaining of a result for the query. If a query is input to interface 100, the terminal can perform the query or can communicate the query to a server and obtain results associated with the query from the server. The terminal can also obtain one or more related objects (e.g., related objects 171-178 of FIG. 1B) associated with the results associated with the query. The terminal provides the one or more related objects (e.g., related objects 171-178) on interface 150 in connection with video data 160. According to various embodiments, video data 160 of interface 150 corresponds to video data 110 of interface 100 of FIG. 1A. For example, if the terminal obtains the one or more related objects, the terminal reduces the video being played back from the full screen format such as video data 110 of interface 100, and displays the video as video data 160 of interface 150 in a partial screen format such that video data 160 takes up less than the entire screen. Video data 160 can be displayed in various positions on interface 150. For example, video data 160 can be displayed in the center of the screen (e.g., of the interface 150). The one or more related objects (e.g., related objects 171-178) can be displayed concurrently with video data 160. The one or more related objects can be positioned such that none of the one or more objects overlap with video data 160.

As illustrated in FIG. 1B, the video data 160 is displayed in the central position of the screen (e.g., of interface 150). One or more related objects are displayed around the video data 160. Interface 150 includes related objects 171-178 provided around video data 160.

The one or more related objects obtained by the terminal can have various formats and be of various types. A first subset of the one or more related objects can be different types of objects than a second set of the one or more related objects. For example, one of the one or more related objects can be a text, and another of the one or more related objects can be an image. As another example, one of the one or more related objects can be obtained using a first application and another of the one or more related objects can be obtained using a second application.

According to various embodiments, the one or more related objects can be provided in one or more corresponding interfaces. For example, related object 171 can be provided in an interface (e.g., a window) on interface 150, related object 172 can be provided in an interface on interface 150, related object 173 can be provided in an interface on interface 150, related object 174 can be provided in an interface on interface 150, related object 175 can be provided in an interface on interface 150, related object 176 can be provided in an interface on interface 150, related object 177 can be provided in an interface on interface 150, and related object 178 can be provided in an interface on interface 150.

According to various embodiments, a related object is selectable. For example, in response to an input associated with the related object to an interface on which the related object is provided, the terminal can perform one or more functions. The one or more functions can include obtaining additional information associated with a selected related object, launching an application associated with the related object, displaying the related object in a full screen format, etc. Playback of the video can be paused or stopped in response to the input.

As discussed above, the related objects displayed around the video (e.g., video data 160 of interface 150) can be related objects of the same type or of different types. For example, the one or more related objects can correspond to the same application type, or the one or more related objects can correspond to different application types. For example, at least two related objects can correspond to different application types. In some embodiments, an application type corresponding to at least one related object differs from the application type of the currently playing video data. The application type of the video data is a multimedia application type, and recommended corresponding application types can include: multimedia application types (e.g., an application that includes or can read MOV and MP4 formatted files), web page application types (such as browser applications and current events news applications, and applications that include or can read HTML formatted files), business application types (such as shopping applications and ticket-purchasing applications), game applications, and so on. For example, the related object presenting interface for related object 171 includes information introducing the star identified in the video frame; the related object presenting interfaces 172 and 173 include information on other movies in which this star (e.g., the star identified in related object 171) has acted; the related object presenting interface 174 includes information on variety shows in which the star (e.g., the star identified in related object 171) has acted; and related object presenting interface 177 includes information on television shows in which the star (e.g., the star identified in related object 171) has acted.

In some embodiments, a related object can correspond to a rating or review of the video data. For example, the related object presenting interface 175 includes evaluative information on the video data. If the video data 160 is a television show or movie, various ratings of the television show or movie, user reviews, and other such data can be associated with the video data 160.

In some embodiments, a related object can include product information associated with the video data. For example, related object presenting interfaces 176 and 178 can include information on official merchandise relating to the video or on the same styles as the star. The related object can include a link to a website or application that allows a user to purchase an associated product (e.g., a product identified or otherwise appearing in the video data 160).

Thus, the user may view the video data 160 associated with the video while simultaneously viewing information on various related objects 171-178 relating to the video. The ability to view information on various related objects 171-178 relating to the video during playback of the video increases the user's viewing interest while also satisfying the various viewing needs of the user. Detailed recommendation content associated with the related object can be displayed after the user clicks on the corresponding related object presenting interface or in response to the user otherwise selecting the related object. As an example, if an input (e.g., a selection) associated with the related object regarding evaluative information is received, then evaluative information by various users can be displayed on the interface in association with the video data. For example, the evaluative information can be displayed next to the video. In some embodiments, in response to receiving a selection of the related object, the terminal can obtain the evaluative information or additional evaluative information, and/or provide such evaluative information or additional evaluative information. The evaluative information or additional evaluative information can be provided during playback of the video. As another example, if the user clicks information on relating objects associated with other movies in which the star (e.g., the star identified in the video data) has acted, then the terminal could switch to playing the other movie associated with the received selection.

FIG. 2 is a flowchart of a method for video play processing on a terminal side according to various embodiments of the present application.

Referring to FIG. 2, process 200 is provided. Process 200 can implement interface 100 of FIG. 1A and/or interface 150 of FIG. 1B. Process 200 can be implemented in connection with process 400 of FIG. 4, process 700 of FIG. 7, and/or process 800 of FIG. 8. Process 200 can be implemented by operating system 900 of FIG. 9 and/or system 1000 of FIG. 10.

At 210, an instruction is obtained during playback of a video. The terminal can obtain video data associated with the video and play back the video data on a screen. The terminal provides (e.g., displays) the video data on an interface such as interface 100 of FIG. 1A. The terminal can provide the video data in a full-screen format. During playback of the video, the terminal can monitor its input interfaces for any received inputs. For example, the terminal can detect an input obtained via a touch screen, via a controller connected to the terminal, via a voice command, etc.

At 220, a request for data is generated. The terminal generates the request for data in connection with the obtaining of the instruction during playback of the video. For example, in response to obtaining the instruction during playback of the video, the terminal generates the request for data. The request for data can be generated based at least in part on the obtained instruction. For example, the terminal can store mappings of instructions to commands or functions. If the terminal obtains an instruction, the terminal can look up the obtained instruction in the mappings of instructions to commands or functions to determine the command or function corresponding to the obtained instruction. In some embodiments, the request for data is generated based at least in part on the video (e.g., the video being played at a time when the instruction is obtained by the terminal). In some embodiments, the request for data is generated based at least in part on the obtained instruction and the video. The terminal can generate the request for data in response to determining that the obtained instruction was obtained during playback of the video.

In some embodiments, the terminal is associated with an account. For example, a user can use the terminal to log into one or more accounts associated with one or more servers. For example, the terminal can run one or more applications, and the one or more applications can have corresponding accounts associated therewith. Accordingly, the request for data can be further based at least in part on an account with which the terminal is registered or logged in. The request for data can include one or more account identifiers, or can be sent in connection with one or more identifiers. In response to receiving a request for data, a server can use the account in connection with determining data responsive to the request for data. For example, the account can be associated with one or more preferences, user information, and/or browsing or other historical usage information, and such preferences, user information, and/or browsing or other historical usage information can be used in determining data that is responsive to the request for data.

In some embodiments, the request for data corresponds to a data acquisition request. For example, the terminal can generate a data acquisition request corresponding to a request for data associated with the video (e.g., a content or one or more characteristics of the video). The instruction can be used in connection with determining a type of data being requested (e.g., to determine the application, or file or media type for which data associated with the video is to be requested).

At 230, the request for data is communicated. The terminal can send the request for data in response to the instruction being obtained and the request for data being generated. The terminal sends the request for data to one or more servers to which the terminal is connected via one or more networks. For example, the terminal can send the request for data to one or more web servers. The one or more web servers can be associated with a web service provided in connection with one or more applications installed on the terminal. The terminal can send the request for data to the one or more servers in order for the one or more servers to perform a query for requested data associated with the request for data. In response to receiving the request for data, the one or more servers query one or more databases based at least in part on the request for data.

At 240, results associated with the request for data are obtained. As an example, the results associated with the request for data are responsive to the request for data. The terminal obtains the results associated with the request for data over one or more networks. For example, the terminal can receive the results associated with the request for data from one or more servers. In response to obtaining the request for data from the terminal, the one or more servers determine the results associated with the request for data and provide the results associated with the request for data to the terminal. The server can communicate the results associated with the request for data to the terminal via one or more networks.

In some embodiments, the results associated with the request for data comprise one or more related objects. For example, the one or servers communicate the one or more related objects to the terminal in response to the terminal communicating the request for data thereto. According to various embodiments, the one or more objects are associated with the video being played at the time that the instruction is obtained. The one or more related objects can correspond to any one or more of related objects 171-178 of FIG. 1B.

In some embodiments, the results associated with the request for data comprise two or more related objects.

At 250, the results associated with the request for data are provided. In response to obtaining the results associated with the request for data, the terminal provides (e.g., displays) the results associated with the request for data. In some embodiments, the terminal provides a part of the results associated with the request for data. For example, if the results associated with the request for data comprise a plurality of related objects (or are associated with the plurality of related objects), the terminal can display a subset of the plurality of related objects. In some embodiments, the terminal displays all the related objects that are obtained in connection with the results associated with the request for data.

According to various embodiments, the terminal provides at least a portion of the related objects associated with the results associated with the request for data. The terminal provides at least the portion of the related objects on an interface. For example, the terminal provides the at least the portion of the related objects contemporaneously with display of the video (e.g., the video data). With reference to FIG. 1B as an example, the terminal can provide the at least the portion of the related objects on interface 150. For example, the at least the portion of the related objects can be provided at interfaces (e.g., a window, a layer, etc.) for any one or more related objects 171-178. The interface on which a related object is provided is also referred to herein as a presenting interface.

In some embodiments, the request for data comprises all or part of the video frame corresponding to the video data. For example, the request for data comprises all or part of the video frame corresponding to the video data being provided contemporaneously with obtaining of the instruction at 210. The one or more related objects that are obtained in connection with the results associated with the request for data are determined according to characteristic information corresponding to all or part of the video frame. Each related object corresponds to one application type, and the application type corresponding to at least one of the one or more related objects differs from the application type of the currently playing video data. The information provided (e.g., displayed) by the presenting interface at least comprises: information relating to the characteristic information on the video data or the information overview relating to the characteristic information on the video data.

Video data is displayed on television and other terminal devices. The video data may use a playing component to conduct full-screen display. The playing component can be a Flash Player, a YouTube component, etc. Full-screen display includes enlarging the video data so that the displayed video data fills the screen. The user can thus view the video clearly. In the process of displaying the video data, a viewing-related prompt message can also be displayed on the screen. The viewing-related prompt message can be pre-stored with (e.g., in association with) the video data, or the video-related prompt message can be identified from the video data and linked to the related application. The viewing-related prompt message can be displayed so as to be overlaid with the video data being played back. The prompt message can be a prompt concerning video content or a prompt concerning other related content, such as merchandise, shopping coupons, viewing coupons, and other items offered as gifts in an advertisement captured from the screen. The user can input a user instruction based at least in part on the prompt message. In addition, the user can request a user prompt when the user desires to view other information relating to the video, such as an article of clothing worn by the star in the video. The television terminal receives the user instruction. If the instruction (e.g., user instruction) input during video playback is received by the operating system or by the application managing the video interface, all or part of the video frame corresponding to the video data may be determined according to the instruction (e.g., the user instruction). For example, the video frame for the video data is captured, or the playing time point corresponding to the instruction is recorded. Then a request for data is generated according to all or part of the video frame. The television terminal sends the request for data to a server.

After receiving the query instruction (e.g., the request for data) and determining the corresponding video frame, the server can determine at least two related objects corresponding to the video frame. The related objects include objects related to the video frame and objects related to the video data. In some embodiments, the at least two related objects include related objects associated with the prompt message, such as interactive task information corresponding to the prompt message. Each related object corresponds to one application type, and the application type corresponding to at least one related object of the at least two related objects differs from the application type of the currently playing video data. The application type is determined according to the application providing the related object information. For example, the related objects are video data and audio data processed and presented by a player app. The corresponding application type is a multimedia application type. As another example, the related objects are news and evaluative information processed and presented by a browser or the application of a corresponding provider. The news and evaluative information can be a web page application type. In the case of shopping information carried by a shopping application, the corresponding related object can be a business application type. According to various embodiments, related objects and information relating to characteristic information on the video data are obtained, and the related objects and information relating to the characteristic information are used in connection with generating (e.g., determining) results associated with the request for data. In response to generating results associated with the request for data, the server sends the results associated with the request for data to the television terminal.

The television terminal receives the results associated with the request for data. The television terminal obtains the related objects based at least in part on the results associated with the request for data. For example, the television terminal obtains the related objects from within the results associated with the request for data. As another example, the television terminal obtains an identifier associated with the related objects from the results associated with the request for data. As another example, the television terminal obtains a link to the related objects, or an address at which the related objects are located, from the results associated with the request for data. The television terminal also obtains information relating to the characteristic information on the video data corresponding to the obtained related object. The television terminal can obtain such information relating to the characteristic information from the results associated with the request for data by parsing the results and obtaining data at pre-specified locations. In response to obtaining the related objects, the television terminal uses a video playing component to display video information on the screen. The television terminal can switch to non-full screen mode (e.g., such that the video data being displayed is no longer presented in a full-screen format), and can use display components to display related object presenting interfaces. The information presented by the presenting interfaces at least includes: information relating to the characteristic information on the video data or an information overview of characteristic information relating to the video. The information overview is for summarizing and representing information relating to characteristic information (e.g., thumbnails, summary information, headlines, etc.). The user thus can see video on the screen and can contemporaneously see the related objects associated with the video. The contemporaneous display of the video and the related objects improves viewing effects and meets user needs.

In addition, after a selection of a related object is received, related object content can be determined based at least in part on the corresponding instruction. For example, if a related object is selected, corresponding information or content associated with the related object can be obtained and/or provided (e.g., displayed) to the user. The television terminal displays the related object content after determining the related object content. For example, the television terminal switches to displaying other video or displays user evaluative information next (e.g., adjacent) to the video data. As another example, the television terminal switches to a detailed merchandise information page for recommending merchandise. The television terminal can display specific interactive task content and thus provide viewing with interactivity.

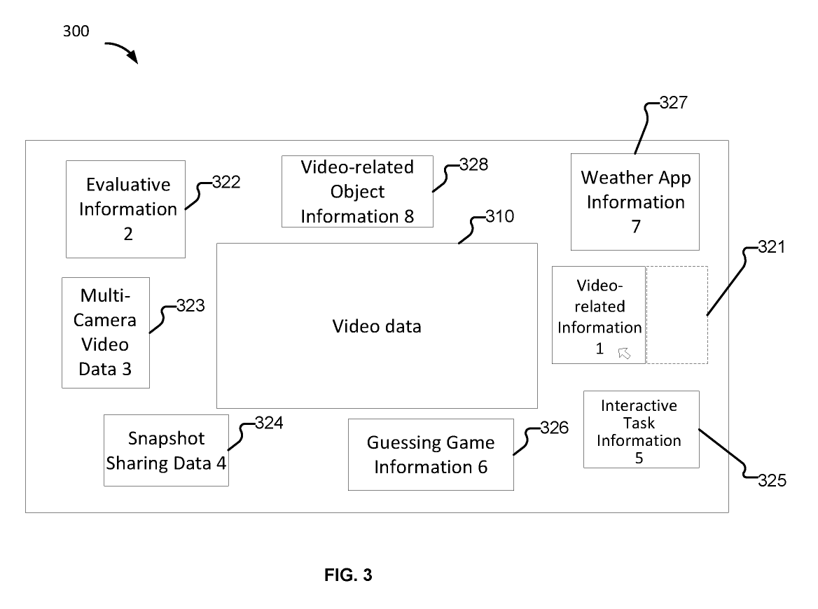

FIG. 3 is a diagram of an interface for displaying related objects according to various embodiments of the present application.

Referring to FIG. 3, interface 300 is provided. Interface 300 can be implemented in connection with process 200 of FIG. 2, process 400 of FIG. 4, process 700 of FIG. 7, and/or process 800 of FIG. 8. Interface 300 can be implemented by operating system 900 of FIG. 9 and/or system 1000 of FIG. 10.

Interface 300 comprises video data 310 and related objects (or information associated with the video data 310. The related objects can be displayed as 321-328 on interface 300.

In some embodiments, the information provided by the presenting interface comprises at least: information relating to the characteristic information of the video data, or an information overview relating to the characteristic information of the video data. The display component has an expanded mode and a retracted mode. The expanded mode is used to present the complete content of a related object. The retracted mode is used to present preview content of a related object. The preview content could be pictures, preview text, etc. In the present embodiment, the related object may comprise display information and descriptive information. The display information includes pictures and other display information in the information relating to the characteristic information on said video data. The descriptive information includes content, such as textual introductions or headlines, describing the related object in the information relating to the characteristic information on said video data. In the expanded mode, it is possible to present display information and descriptive information. It is also possible to determine an information overview relating to the characteristic information on said video data. This information overview is displayed when in retracted mode.

According to various embodiments, interface 300 can be provided (e.g., displayed) by a terminal in connection with video playback. For example, if a query or other input is input to the terminal, interface 300 is displayed in response to an obtaining of a result for the query or a result of an instruction associated with the input. If a query or other input is input to the terminal during video playback, the terminal can perform the corresponding query or can communicate the corresponding query to a server and obtain results associated with the corresponding query from the server. The terminal can also obtain one or more related objects (e.g., related objects 321-328 of FIG. 3) associated with the results associated with the query. The terminal provides the one or more related objects (e.g., related objects 321-328 of FIG. 3) on interface 300 in connection with video data 310. According to various embodiments, video data 310 of interface 300 corresponds to video data 110 of interface 100 of FIG. 1A. For example, if the terminal obtains the one or more related objects, the terminal reduces the video being played back from the full screen format such as video data 110 of interface 100, and displays the video as video data 310 of interface 300 in a non-full screen format such that video data 310 takes up less than the entire screen. Video data 310 can be displayed in various positions on interface 300. For example, video data 310 can be displayed in the center of the screen (e.g., of the interface 300). The one or more related objects (e.g., related objects 321-328) can be displayed concurrently with video data 310. The one or more related objects can be positioned such that none of the one or more objects overlap with video data 310.

As illustrated in FIG. 3, the video data 310 may be displayed in the central position of the screen (e.g., of interface 300). One or more related objects are displayed around the video data 310. Interface 300 includes related objects 321-328 provided around video data 310.

The one or more related objects obtained by the terminal can have various formats and be of various types. A first subset of the one or more related objects can be different types of objects than a second set of the one or more related objects. For example, one of the one or more related objects can be a text, and another of the one or more related objects can be an image. As another example, one of the one or more related objects can be obtained using a first application and another of the one or more related objects can be obtained using a second application.

One or more related objects 321-328 can be displayed in a presenting interface. For example, one or more related objects 321-328 can be displayed in a window or layer disposed in (or on) interface 300.

FIG. 4 is a flowchart of a method for play processing on a terminal side according to various embodiments of the present application.

Referring to FIG. 4, process 400 is provided. Process 400 can implement interface 300 of FIG. 3. Process 400 can be implemented in connection with process 200 of FIG. 2, process 700 of FIG. 7, and/or process 800 of FIG. 8. Process 400 can be implemented by operating system 900 of FIG. 9 and/or system 1000 of FIG. 10.

At 405, a video is provided. The terminal displays the video on a screen thereof. In some embodiments, the terminal provides the video in a full-screen format or full-screen mode. For example, the terminal can adjust a size of the video being played back to correspond to the full-screen mode (e.g., such that the video is displayed on substantially all of the screen). As an example, referring to FIG. 1A, the video can be provided as video data 110 on interface 100.

At 410, an instruction is obtained during playback of a video. The instruction can be a user instruction. The terminal can obtain video data associated with the video and play back the video data on a screen. The terminal provides (e.g., displays) the video data on an interface such as interface 100 of FIG. 1A. The terminal can provide the video data in a full-screen format. During playback of the video, the terminal can monitor for any received inputs. For example, the terminal can detect an input obtained via a touch screen, via a controller connected to the terminal, via a voice command, etc.

The instruction can be obtained in connection with a prompt message. For example, with reference to FIG. 1A, a prompt message 120 can be displayed in connection with the playback of the video, and a user instruction can be input to the terminal in connection with (e.g., in response to) the prompt message 120.

At 415, a playing time of the video is determined. The playing time of the video corresponds to a time point at which the instruction is obtained during playback of the video. The terminal can determine the time at which the instruction is obtained and thereafter determine a playing time of the video at which the instruction is obtained. The playing time of the video can be used in connection with obtaining information or content of the video. The information or content of the video can be used in connection with requesting data (e.g., associated with the video) from one or more servers.

A playing component in the television or other terminal may be used to play the video (e.g., the video data). The full-screen mode of the playing component can be employed for full-screen playing of the video. During playback of the video, the playing component displays a prompt message. For example, the prompt message displayed during playback can correspond to prompt message 120 of FIG. 1A. According to various embodiments, the prompt message is configured to present video-related information. For example, the prompt presents information relating to a character or the plot in the video being played back or task information corresponding to the video (e.g., the task of capturing a sign image appearing in a variety show or gala). As another example, the prompt presents time information such as mealtime or bedtime or benefit information such as viewing coupons. The prompt message can be provided in response to a user instruction. In response to the user selecting the prompt message (or in response to receipt of another preset input), further information regarding the video-related information associated with the prompt message can be provided. In addition, the user can also input a user instruction if there is another video-related need during the viewing process.

The obtained instruction (e.g., the user instruction) can be input to the terminal according to various input/output interfaces. In some embodiments, the instruction is communicated to the terminal by a client terminal. For example, the client terminal communicates the instruction to the terminal in response to a preset input to the client terminal. In some embodiments, the user instruction is triggered by a designated key that is provided on a remote control device. The remote control device can communicate with the terminal via a wired connection, a wireless connection, or via a network. For example, the remote controller can communicate with the television terminal via infrared or otherwise. The remote control device can be a remote controller, a mobile terminal, or any device that provides remote control functions. Thus, the designated key could be a pushbutton on a remote controller, with the pushbutton corresponding to an attribute code. Selecting the button can send the attribute code to a television terminal. The television terminal analyzes the attribute code or searches a mappings of attribute codes to instructions to determine the user instruction corresponding to the attribute code. A mobile terminal can use an application to communicate wirelessly with the television terminal. Thus, the application on the mobile terminal provides a user interface for television control. The user interface includes a button as the designated key or provides a functionality the invocation or selection of which causes the mobile terminal to send to the television terminal the corresponding user instruction. Triggering (e.g., inputting a selection of) the button causes the mobile terminal to communicate a user instruction to the television terminal. The user instruction can be sent via a local area network, directly to the smart television, or can be forwarded to the television terminal via a server.

According to various embodiments, the prompt message that is provided on the terminal (e.g., the smart television) can prompt a user to input a predefined input (e.g., selection of a predefined key) for viewing. For example, the prompt message can provide a reminder of a function associated with a designated key (e.g., the ‘OK’ key or any other key on the remote controller or smart phone, etc.). In some embodiments, selection of the designated key will cause display of different data based at least in part on the context (e.g., an application running on the smart terminal, a video content of the video being provided, a type of the video, etc.). Therefore, in response to the user instruction corresponding to the designated key being obtained, a status of the terminal (e.g., the smart television) can be determined. For example, in response to the user instruction being obtained, the terminal can determine whether the current status is video playing or not video playing. The terminal can display information based at least in part on the determined status of the terminal. For example, in response to determining the status of the terminal, the terminal displays different information depending on whether the terminal is currently playing a video or not playing the video.

At 420, a request for data is generated. The terminal generates the request for data in connection with the obtaining of the instruction during playback of the video. For example, in response to obtaining the instruction during playback of the video, the terminal generates the request for data. The request for data can be generated based at least in part on the obtained instruction. For example, the terminal can store mappings of instructions to commands or functions. If the terminal obtains an instruction, the terminal can look up the obtained instruction in the mappings of instructions to commands or functions to determine the command or function corresponding to the obtained instruction. In some embodiments, the request for data is generated based at least in part on the video (e.g., the video being played at a time when the instruction is obtained by the terminal). In some embodiments, the request for data is generated based at least in part on the obtained instruction and the video. The terminal can generate the request for data in response to determining that the obtained instruction was obtained during playback of the video. The terminal can generate the request for data based at least in part on the playing time of the video. For example, the terminal can use the playing time of the video to obtain information or content of the video (e.g., a frame of the video, metadata associated with the video, etc.). If the terminal obtains (e.g., determines) the information or content of the video, the terminal can include the information or content of the video in the request for data, or communicate the information or content of the video in connection with the request for data.

In some embodiments, the request for data is generated based at least in part on the instruction (e.g., the user instruction) and a video frame associated with the video being played back. The video frame can correspond to the video data being displayed at a time when the instruction was obtained (e.g., when the instruction was input).

In response to the terminal (e.g., the smart television) obtaining the instruction (e.g., the user instruction), the terminal determines a video frame based on the user instruction. For example, in response to the terminal receiving the user instruction, the terminal extracts the video frame. The extracted video frame can correspond to video data being played by the terminal at the time that the instruction is received. The user instruction serves as a basis for determining a playing time point. The “playing time point” refers to the time point at which the video is currently played.

The video frame can be determined according to various techniques. As an example, the video frame is extracted by executing a screenshot operation according to the playing time point corresponding to the obtained instruction. As another example, the video frame of the playing time point corresponding to the obtained instruction is acquired from the video buffer.

According to various embodiments, the request for data is generated based at least in part on the video frame. For example, in connection with the determining and/or generating of the request for data, the video frame is encoded and added to the request for data. In some embodiments, the playing time point is added to the request for data. In some embodiments, a characteristic value for the video frame is determined (e.g., computed) and added to the request for data. In some embodiments, an identifier associated with the video frame corresponding to the playing time point is communicated in connection with the request for data. For example, the identifier associated with the video frame is comprised in the request for data. As another example, the identifier associated with the video frame is communicated contemporaneously with the request for data. According to various embodiments, the request for data comprises full video frame information or partial video frame information. The full video frame information or partial video frame information comprised in the request for data facilitates matching a request for data with the video frame-related object.

In some embodiments, the instruction (e.g., the user instruction) is input based at least in part on a prompt message. For example, the instruction can be input in response to the prompt message being displayed. According to various embodiments, a determination as to whether a prompt message was played within a preset time prior to the input (or receipt) of the instruction (e.g., the user instruction) is determined. As an example, a terminal (e.g., the smart television) can determine whether the user instruction was input, or received, within a preset time period of the prompt message. As another example, a server, such as the server that obtains the generated request for data, can determine whether the user instruction was input, or received, within a preset time period of the prompt message. In some embodiments, if a prompt message was displayed, then a prompt parameter corresponding to the prompt message is determined according to the user instruction. The prompt parameter can comprise information associated with the prompt message. The prompt parameter can be added to the request for data. For example, if the prompt message presents a task (e.g., get or download the icon in a variety show, etc.), then the prompt parameter could be a task-related parameter. If the prompt message presents plot and task information, then the prompt parameter could be a video-related parameter. If the prompt message presents a benefit (e.g., a coupon), then the prompt information could be a benefit parameter. Thus, if the prompt parameter is added to the request for data, the server can use the request for data as a basis for matching a related object corresponding to the prompt parameter.

According to various embodiments, the request for data comprises one or more of the following: a video frame, a playing time point, a prompt parameter, a characteristic value of a video frame, a video frame identifier, a video identifier, an identifier of a user associated with the terminal, and an identifier associated with the terminal. The data acquisition request is communicated to a server.

At 425, the request for data is communicated. The terminal (e.g., the smart television) can send the request for data in response to the instruction being obtained and the request for data being generated. The terminal sends the request for data to one or more servers to which the terminal is connected via one or more networks. For example, the terminal can send the request for data to one or more web servers. The one or more web servers can be associated with a web service provided in connection with one or more applications installed on the terminal. The terminal can send the request for data to the one or more servers in order for the one or more servers to perform a query for requested data associated with the request for data. In response to receiving the request for data, the one or more servers query one or more databases based at least in part on the request for data.

At 430, results associated with the request for data are obtained. As an example, the results associated with the request for data are responsive to the request for data. The terminal obtains the results associated with the request for data over one or more networks. For example, the terminal can receive the results associated with the request for data from one or more servers. In response to obtaining the request for data from the terminal, the one or more servers determine the results associated with the request for data and provide the results associated with the request for data to the terminal. The server can communicate the results associated with the request for data to the terminal via one or more networks.

In some embodiments, the results associated with the request for data comprise one or more related objects. For example, the one or servers communicate the one or more related objects to the terminal in response to the terminal communicating the request for data thereto. According to various embodiments, the one or more objects are associated with the video being played at the time that the instruction is obtained. The one or more related objects can correspond to any one or more of related objects 171-178 of FIG. 1B or any one or more of related objects 321-228 of FIG. 3.

In some embodiments, the results associated with the request for data comprise one or more identifiers associated with one or more related objects, a location from which the one or more related objects can be obtained (e.g., a network address, a URL, etc.), and/or a link to the one or more objects. The one or more objects can be communicated to the terminal in connection with (e.g., contemporaneously) the results associated with the request for data.

In some embodiments, the results associated with the request for data comprise two or more related objects.

The server can use various matching methods to obtain related objects and information thereon in connection with generating the results associated with the request for data. Further description relating to the generating the results associated with the request for data by the server is provided in connection with the description of FIG. 7.

The terminal (e.g., the smart television) can receive the results associated with the request for data that are provided by the server as feedback. In some embodiments, at least two related objects are acquired from the results associated with the request for data. The related objects can include at least one related object corresponding to the video frame. The related objects can include at least one related object corresponding to a prompt message.

At 435, a display of the video is modified, and information and/or a related object is provided. In the event that the terminal obtains the results associated with the request for data, the terminal can modify the display of the video. For example, the terminal causes playback of the video to be modified from a full-screen mode to a mode in which the video is not displayed in full-screen format. The terminal can exit the full-screen mode and provide the video in a reduced size format (e.g., relative to the full-screen format). In addition to providing the video data, the terminal also provides information and/or one or more related objects. The information and/or one or more related objects can be associated with the video being provided by the terminal. For example, in response to the terminal obtaining the results associated with the request for data, the terminal can provide information associated with the results and/or one or more related objects associated with the results. The terminal can provide the information associated with the results and/or one or more related objects associated with the results in one or more corresponding presenting interfaces.

The terminal can exit from the full-screen mode in connection with the terminal obtaining the results associated with the request for data. For example, so as not to affect user viewing while displaying the related objects, the playing component that is providing playback of the video can exit from full-screen mode and switch to non-full screen mode to play the video data. As illustrated in FIG. 1B, video data 160 is displayed in the middle of the screen (e.g., in the middle of interface 150). The video data can be displayed in various positions of the screen. For example, a position of video data 160 in interface 150 can be adjusted based on user preferences, user settings, historical usage, a number of related objects to be displayed, and/or an input received from a user. For example, the video data 160 can be displayed in the four corners of the screen or in another position. Various embodiments of the present application impose no restrictions in this regard.

While video data is being provided, at least one display component may be provided somewhere on the screen other than the playing component position. For example, during playback of the video, the terminal can display information associated with the results and/or one or more related objects associated with the results so as to not be overlaid with the video data. The at least one display component is used to display a presenting interface for a related object. In some embodiments, one display component corresponds to one related object. As shown in FIG. 1B, eight components are used to present presenting interfaces for eight related objects (e.g., related objects 171-178). For the purpose of differentiation, the interface presenting the video data and the related objects can be referred to herein as “the main interface.” In the context of FIG. 1B, the main interface can correspond to 150 and the video data 160 and the related objects 171-178 are presented on the main interface.

In some embodiments, the information provided by the presenting interface comprises at least: information relating to the characteristic information of the video data, or an information overview relating to the characteristic information of the video data. The display component has an expanded mode and a retracted mode. The expanded mode is used to present additional content of a related object. For example, the expanded mode can provide the complete content associated with a related object. As another example, the expanded mode can provide more content associated with a related object than is provided in a retracted mode of the display component for the related object. The retracted mode of a display component provides less content associated with a related object than is provided by the expanded mode of the display component. For example, the retracted mode is used to present preview content of a related object. The preview content can be pictures, preview text, etc.

According to various embodiments, a related object comprises display information and descriptive information. The display information can correspond to pictures and other display information in the information relating to the characteristic information associated with the video data. The descriptive information can be content, such as textual introductions or headlines, describing the related object in the information relating to the characteristic information associated with the video data. If the display component is in the expanded mode, display information and descriptive information can be provided. If the display component is in the retracted mode, an information overview relating to the characteristic information associated with the video data can be provided. For example, an information overview relating to the characteristic information associated with the video data can be determined and displayed in connection with the video data.

In some embodiments, if a display component provides a presenting interface for a related object, a focal point position is a basis for determining the display mode of the display component. As an example, the focal point position can be determined by the remote controller or by a touch to the screen. If the focal point is positioned over the display component, the display component uses the expanded mode to display the related object. If the focal point is not positioned over the display component, the display component uses the retracted mode to display the related object. The focal point refers to an area receiving attention. For example, the focal point can correspond to a position at which the current cursor is activated or the position that is currently touch-selected.

Accordingly, the expanded view of a display component can be displayed when a cursor is on or within a preset threshold distance to the display component (e.g., when the cursor is hovering over the display component), and the retracted mode of the display component can be displayed when a cursor is not on or within the preset threshold distance to the display component. In some embodiments, the expanded view of a display component can be displayed when the display component or corresponding related object is selected.

Referring to FIG. 3, the focal point is positioned over the display component corresponding to related object 321 that is displaying Video-related Information 1 on interface 300. This display component corresponding to related object 321 is in expanded mode and can display the descriptive information in the area delineated by the dashed-line frame while displaying the information overview for Video-related Information 1. For example, Video-related Information 1 is information on television shows in which the star associated with video data 310 has acted. As an example, if the display component is in the retracted view, the display component can provide display information such as the promotional cover picture and the title of the television show. In contrast, if the display component is in the expanded view, the display component can provide display information such as the promotional cover picture of the television show, a title of the television show, a rating of the television show, and a summary of the television show. In some embodiments, if the focal point on the screen is not positioned over another display component, the other display components will continue to be provided in the retracted mode to display corresponding related objects.

A display template can be used in connection with providing the video data at a primary position of the interface (e.g., video data 310 displayed in the center of interface 300) and providing the related objects at auxiliary positions of the interface. For example, with reference to FIG. 3, the related objects 321-328 are provided in auxiliary positions of interface 300 around video data 310. The related objects 321-328 can be provided in the corresponding presenting interfaces at the various auxiliary positions. In some embodiments, the related objects can be populated in a display template and provided on the screen. In some embodiments, a display template can be pre-configured. For example, a terminal (e.g., a smart television) can store one or more display templates for use in connection with displaying related objects while video data is being provided. The terminal can obtain a display template from a server. The display template can be configured in advance for the layout of video data and related objects. A display template can be provided with a primary position and at least one auxiliary position. The video data can be played at the primary position. As illustrated in FIG. 3, if the video data is displayed at the primary position, then the primary position is in the center of interface 300 at which video data 310 is provided. A playing component can be used at the primary position of the display template to play video data. According to various embodiments, each auxiliary position corresponds to one playing component. For example, each auxiliary position can correspond to one related object. Thus, presenting interfaces of related objects can be displayed at the auxiliary positions.

A terminal can control the display component to be provided at the primary position, and the position of one or more display components corresponding to the related objects. For example, the terminal can toggle the positioning of related object and video data being provided. The terminal can control the display component to be provided at the primary position, and the position of one or more display components corresponding to the related objects in response to an input (a selection) from a user, one or more user preferences, etc.

A terminal can control whether video data is to be provided in a full-screen mode, or whether the video data is to be provided at a primary position of a display template. For example, the display of video can be switched from full-screen playing to primary-position playing, or switched from primary-position playing to full-screen playing based at least in part on an input from a user, such as a selection of a designated key. The designated key can be provided on a remote control device, a mobile terminal, and/or the terminal. The playing component can control the size, shape, and/or position of the video playing interface (e.g., the interface in which video data 310 is provided). One main interface (e.g., interface 300 of FIG. 3) can display two or more windows playing video data and displaying related objects. Moreover, the presenting interfaces of different related objects can be switched between the various auxiliary positions. The auxiliary positions can be switched according to the user instruction, according to user habits, etc.

In some embodiments, while video data is being played and related objects displayed in the interface, all or some of the related objects may be adjusted accordingly when the played content in the video data changes. For example, with regard to the related object in the viewing enhancement category, a related object includes a star introduction page for the television shows in which the star acted. The star can be determined based on the video frame. For example, the video frame can be analyzed and a star captured in the video frame can be identified (e.g., determined) using image matching techniques. Thereafter, related objects associated with the star can be provided while the video data is playing back. When the video playing processing includes displaying corresponding video in which another star acted, the related object can be adjusted to the introduction page for such other object and to the television shows in which such other star acted. Thus, the user can be given various kinds of necessary information based on the related object corresponding to the video playing adjustment. In some embodiments, the providing of the related object is adjusted. For example, the content for the related object can be adjusted. As another example, the positioning, shape, or size of the displaying interface for the related object can be adjusted. Adjustment to the video playing or in connection with the related object can be set according to a preset interval. For example, a data frame and other such information may be uploaded at frames of set intervals or at set times, and based on the updated data frame or other such information, a corresponding related object is obtained.

The above-described display mode according to which a video is played and related objects are displayed in the interface can be referred to herein as a modal display, and the display mode according to which video data is displayed and the related objects are not displayed can be referred to herein as a conventional display. In some embodiments, the display can be toggled between at least the conventional display and the modal display. For example, the terminal can switch between the conventional display and the modal display. The terminal can switch between the conventional display and the modal display in response to obtaining an instruction for such switching. The instruction can be input by a user via a remote control, a mobile terminal, a voice input, an input to the terminal, etc. For example, selection of a designated key, if the terminal is in the mode including the conventional display, can invoke the terminal to switch to a mode including the modal display. Conversely, selection of a designated key, if the terminal is in the mode including the modal display, can invoke the terminal to the mode including the conventional display.

At 440, determine that detailed information associated with a related object is to be provided. The terminal can determine to provide detailed information associated with the related object based at least in part on an input to the terminal. For example, the terminal can determine to provide detailed information associated with the related object based on obtaining information that is input to the terminal via a remote control, a mobile terminal, a voice input to the terminal, or an input directly to the terminal (e.g., such as via a touch screen). The detailed information includes the display information and descriptive information of the corresponding related object. For example, the determining to provide detailed information associated with the related object can include determining to display the display component corresponding to the related object in the expanded mode (e.g., to switch the display component from the retracted mode to the expanded mode). In some embodiments, the detailed information comprises at least part of the information that is obtained from the results associated with the request for data.

In response to determining to provide detailed information associated with the related object, display information and descriptive information of the corresponding related object can be provided (e.g., displayed).

As an example, the detailed information corresponding to a related object is determined to be provided based at least in part on a determination that the focal point (e.g., a cursor) is positioned over a display component (e.g., of the related object or a portion of the interface displaying the related object). Upon determining that the focal point (e.g., a cursor) is positioned over a display component (e.g., of the related object or a portion of the interface displaying the related object), the detailed information associated with the related object is provided (e.g., displayed). As another example, the detailed information corresponding to a related object is determined to be provided based at least in part on a determination that the focal point (e.g., a cursor) is positioned over or in proximity (e.g., within a predefined threshold distance) to a display component.

At 445, detailed information associated with a related object is provided. In response to determining the detailed information associated with the related object at 440, the detailed information associated with the related object is provided. As an example, providing the detailed information associated with the related object comprises displaying the related object such that the corresponding display component is in the expanded view. Referring to FIG. 3, related object 321 is provided in a manner in which a related object for which the detailed information is provided.

If the user is interested in a related object, the user can move the cursor to the display component at which the related object is located or the user can position the focal point over the display component by touch-selecting a display component via a touchscreen device. Accordingly, the system or an application (e.g., an application executed on the terminal such as a smart television) can determine the position of the focal point and determine that the focal point is positioned over a display component. If the system or the application determines that the focal point is positioned over a display component, the display component is switched to expanded mode and display information and descriptive information associated with the related object are displayed.

At 450, a selection of a related object is received. The terminal can receive selection of a related object from a user via a remote control, a mobile terminal, a voice input to the terminal, or an input directly to the terminal (e.g., such as via a touch screen). Selection of the related object can be obtained based on an input to a button or link presented on the interface being displayed, or via selection of a button or the like that is mapped to a selecting function. In some embodiments, the selection of the related object includes a hovering event such as a hovering of a cursor over a corresponding related object (e.g., the related object that is subject to selection). Other techniques for determining that the related object is selected can be used. In some embodiments, the related object subject to the selection corresponds to the related object for which detailed information is provided. For example, the related object subject to the obtained selection can correspond to the related object for which the corresponding display component is displayed in the expanded mode.

At 455, a request for content is generated. In response to determining that the related object is selected, the terminal generates a request for content. The terminal can send the request for content to one or more servers via one or more networks. The request for content corresponds to a request for content associated with the selected related object. The request for content can comprise one or more of an identifier associated with the selected related object, information associated with the selected related object, an identifier associated with the video data provided (e.g., video data 310 of FIG. 3), a video frame associated with the video data provided, a time point indicating a time (e.g., in relation to the video data provided) at which the related object is selected, a type of content being requested, a type of application associated with the related object, etc.

At 460, the request for content is communicated. In response to generating the request for content, the terminal communicates the request for content to one or more servers via one or more networks. The one or more servers can query one or more databases for information that is responsive to the request for content.

If the user wishes to view further a related object of interest, the user can select the display component corresponding to the related object. A corresponding selection instruction is thus received. The selected related object can correspond to a related object provided at a location at which the focal point was previously positioned. In some embodiments, the related object is selected after the focal point shifts to a certain related object. The selection instruction associated with the selection of the related object can serve as a basis for obtaining data relating to a related object. For example, the link address for the related object is determined, and a request for content is generated based on the data relating to the related object. The request for content is sent to the corresponding web server. The web server can be a server for providing related objects. One or more servers to which the request for content is communicated at 460 can be different from the one more servers to which the request for data is communicated at 425. To differentiate, the server that provides related objects is referred to herein as the main server. For example, the main server corresponds to the server that sends results based on the request for data. The main server can also be another business server that provides raw data corresponding to related objects. Examples of such a business server include a video server that provides video data and a web page server that provides web page data.

In some embodiments, the request for content corresponds to a web page request. For example, the request for content can correspond to a request for content relating to the related object to be provided to a web page.

At 465, results associated with the request for content are obtained. As an example, the results associated with the request for content are responsive to the request for content. The terminal obtains the results associated with the request for content over one or more networks. For example, the terminal can receive the results associated with the request for content from one or more servers. In response to obtaining the request for content from the terminal, the one or more servers determine the results associated with the request for content and provide the results associated with the request for content to the terminal. The server can communicate the results associated with the request for content to the terminal via one or more networks.

At 470, content corresponding to the results associated with the request for content is provided. The content that is provided can be a subset of the results associated with the request for content. The content corresponding to the results associated with the request for content relates to the related object that is subject to the request for content. The terminal can display the content contemporaneously with playback of the video, or the terminal can display the content on an interface on which video playback is not provided.

The web server to which the request for content is communicated can return response information according to the request for content. For example, the web server returns web page data in response to the request for content if the request for content corresponds to a web page acquisition request. As another example, the web server communicates multimedia data in response to the request for content if the request for content corresponds to a request for multimedia.

After the response information is received (e.g., the results associated with the request for content), the response information can serve as a basis for displaying the corresponding content. In some embodiments, the content is displayed while video data continues to be displayed. For example, a playing component is used to display video data content, or a previously selected display component is used to display recommendation content. As an example, the related object corresponds to benefit information such as viewing a coupon. In response to selection of the display component (or corresponding related object), the content is displayed. The content can correspond to content for input of user information, or an identifier such as a benefit code (coupon code) for obtaining the benefit. In some embodiments, the playing of video data is exited (e.g., playback of the video is discontinued) and the display is switched to corresponding content (e.g., a web page, an application interface for an application associated with the related object, an input form, a media file, etc.). For example, if the content corresponding to the results associated with the request for content comprises web page data and the web page data is to be provided, a browser for displaying a corresponding web page can be invoked. For example, the web page data can serve as a basis for calling a browser to switch to displaying a web page. As another example, in the case of audiovisual or other multimedia data comprised in the content corresponding to the results associated with the request for content, a playing component is used to play the multimedia data.

Thus, it is possible to enable the user to execute other operations during video playback. The viewing of other information and the operations do not affect playing of the video. The ability to view information relating to the video data during playback of the corresponding video improves user experience and can meet various user needs. According to various embodiments, various kinds of related objects can be pushed to the user while video is playing. The related objects can correspond to one or more of the following categories: viewing enhancement category, chat category, interaction category, business category, and application category.

Related objects in the viewing enhancement category are related objects that improve viewing effects. The related objects in the viewing enhancement category are related to played video data. The related objects in the viewing enhancement category can increase the user's interest in viewing and can also meet various viewing needs of the user. Related objects in the viewing enhancement category can comprise one or more of related video data, related audio data, evaluative information, video descriptive information, multi-camera video data, video-related object information, etc. Related video data includes other video data that is related to the video (e.g., the video being played such as video corresponding to video data 310 of FIG. 3). Examples include related video data video such as interesting sidelights or trailers concerning the video; video such as other movies, television shows, and variety shows in which an actor identified in the playing video has acted; other films by the director of the playing video, etc. Related audio data includes other audio data relating to the video (such as, for example, audio data such as the opening song, the concluding song, interludes, and background music relating to the video). Evaluative information includes evaluative data associated with the video such as, for example, user ratings and reviews appearing on various film review websites and video websites, reviews by professional film reviewers, and film review data by users on social networking websites. Video descriptive information includes descriptive information associated with the video data such as, for example, actor information, plot introductions, episode plots, update/completion status, etc. Multi-camera video data includes video data shot from multiple camera angles associated with the video such as, for example, video data shot from different cameras during direct broadcasting or video data shot from different cameras during a large-scale performance such as a concert or gala. As an example, video-related object information can include information associated with an object included (e.g., displayed) in the video data, or with an object that is otherwise related to the video data.

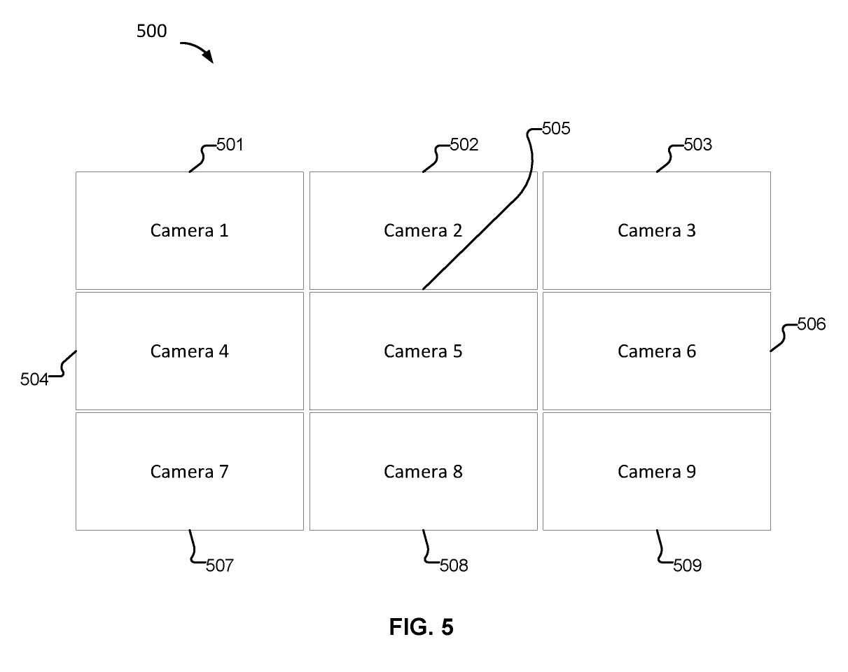

FIG. 5 is a diagram of an interface for displaying multi-camera recommendation content according to various embodiments of the present application.

Referring to FIG. 5, interface 500 is provided. Interface 500 can be implemented in connection with process 200 of FIG. 2, process 400 of FIG. 4, process 700 of FIG. 7, and/or process 800 of FIG. 8. Interface 500 can be implemented by operating system 900 of FIG. 9 and/or system 1000 of FIG. 10. Interface 500 can be implemented in connection with interface 100 of FIG. 1A, interface 150 of FIG. 1B, and/or interface 300 of FIG. 3.

As illustrated in FIG. 5, video data from a plurality of videos can be displayed. For example, video data for the plurality of videos can be displayed concurrently in a plurality of display components 501-509. Each of the display components can comprise zero or one video playing. In some embodiments, the plurality of videos correspond to different camera positions (e.g., camera angles) for the same video (e.g., different angles for the same event). Interface 500 for the terminal screen can comprise display components for camera positions 1 through 9. The user can select from video data from one or more angles (e.g., corresponding to video provided in one or more of display components 501-509). Certain permissions can be associated with one or more of the videos that can be provided in the various display components. For example, one or more of the videos can require that a user or terminal have a certain set of permissions in order to view the video data. The one or more videos can be provided on a subscription basis. For example, the video data from different cameras can have differing sets of permissions required in order to allow viewing (e.g., in order for the terminal to provide the video data). The cameras a user can select would be selected according to differences in user levels (e.g., user permissions). For example, an ordinary user (e.g., a user with a first set of permissions) could select from cameras 1 through 6 (e.g., corresponding to display components 501-506); in contrast, a VIP user (e.g., a user with a second set of permissions that are deemed to be higher permissions than the first set of permissions) could select any of cameras 1-9 (e.g., corresponding to display components 501-509).

In some embodiments, the viewing enhancement information includes video-related object information. Examples of video-related object information include data on merchandise associated with the video, a merchandise page for clothing of the same style as a star identified in the video, etc.

Related objects in the chat category correspond to chat communication-related objects executed during the video playing process. Related objects in the chat category can comprise one or more of chat content data, snapshot sharing data, and video sharing data. Chat content data includes chat data sent by users through various forms of instant messaging. An example of chat content data corresponds to chat data sent with an instant messaging application. Snapshot sharing data includes shared video snapshot data. For example, snapshot sharing data includes indicating information for screenshot sharing, and thus the recommended content displayed after corresponding triggering is screenshot sharing information. Examples include information such as the link address or QR code for the location at which the screenshot data is stored. Video sharing data includes sharing information for the video data and/or related video data. An example of video sharing data is indicating information for video sharing, whereby a user could share one or more videos with other related friend users.

Related objects in the interaction category are objects that make use of various forms of interaction. Related objects in the interaction category can comprise one or more of guessing game information, voice “bullet screen” data, interaction object information, and interactive task information. Guessing game information can include guessing games involving played content in the video data. Examples include guessing games about the results of played singing competitions or guessing games about athletic competitions such as soccer or basketball. Guessing game information can correspond to information that is displayed in connection with a trivia event or a trivia application. A display component can display guessing game options, or a display component may be used to display multiple kinds of guessing game information such as a robot performing a voiced guessing game. Voice “bullet screen” data includes “bullet screen” data input in the form of speech. The voice data can be received and converted into text content, and displayed as a “bullet screen” on the video data. As an example, a “bullet screen,” or “dan mu” in Chinese, is a screen (e.g., a presentation of information) that allows viewers' typed comments to zoom across the screen like bullets, and is an emerging craze on online video sites in China and Japan, where the “bullet screen” is popular mainly with the young for its social interactivity. Interaction object information includes information on business objects that execute interactions. Examples include information about grabbing “red envelopes” or benefit information on gifts of viewing coupons, VIP memberships, etc. Interaction task information includes information on interaction tasks, e.g., the task of capturing a designated object in a video. For example, a video will display an advertising picture from time to time, and the task is to take a snapshot of size X containing the advertising picture.

Related objects in the application category are objects associated with related applications. Related objects in the application category can comprise one or more of exercise application information, game application information, timer alert information, weather application information, and information application information. Exercise application information includes information on various kinds of exercise applications. Thus, the videos can be displayed and used in connection with an exercise program. For example, as the user runs while viewing a video, the user can use the exercise application to calculate the number of steps, heart rate, and other such information. Gaming application information includes information on gaming applications. Gaming application information can correspond to information on gaming applications related to the video such as, for example, application information on games adapted from the video or information on the original version of the game corresponding to the video from which the game was adapted. Gaming application information can correspond to other game information. Timer alert information includes various kinds of time alert information. Timer alert information could be alert times such as for an alarm clock set by the user, or the timer alert information could be a general-purpose time alert such as, for example, a reminder that the user should eat, a reminder that the user should sleep, or a reminder that the user should send mail at a certain time. Weather application information comprises weather-related alert information, such as weather information for the location determined by the weather application, as well as certain weather alerts, clothes-wearing indices, and other such information. Information application information includes information pushed with regard to various current event news, such as the day's headlines, trending news, and entertainment gossip.

The video-related object information, interaction objects, and other such information may include advertising and shopping information, purchase links, and various other kinds of business operating information. In this way, various kinds of information may be recommended for various objects relating to the video. Thus, while watching a video, a user can, via interactions with a designated key, enter a mode in which viewing is simultaneous with X, enabling the user to view information (e.g., various kinds of pushed information) on various kinds of related objects while watching the video. This meets various needs of the user, X being the various operations executed (or various types of information displayed, etc.) according to the user's needs.

In some embodiments, the response information serves (e.g., results associated with the request for content) as a basis for displaying corresponding content in the interface. For example, the playing component in the main interface can be used in connection with switching to playing the video data corresponding to the response information. As another example, the display component in the main interface can be used in connection with displaying content corresponding to response information in a presenting interface. After the related object presenting interface is triggered (e.g., selected), a server can be used to give response information as feedback for displaying corresponding content. For example, the server can provide results associated with the request for content. As another example, if the response information (e.g., the results associated with the request for content) includes video data, the playing component in the main interface can be used to recommend playing of the raw video data and to switch to playing the video data corresponding to the response information (e.g., switching from playing Movie A to playing Movie B). A display component can also be used in the main interface to display corresponding content in a presenting interface (e.g., to display review information). The corresponding application component in the main interface can also be activated to display content, such as a browser component displaying a web page, or such as a shopping component displaying a shopping page. The application component could be an independent application or a plug-in.

The receiving of response information as feedback (e.g., results associated with the request for content) and using the response information in the interface in connection with displaying corresponding content comprises: if the multi-camera video data is triggered, receiving video data corresponding to the selected camera; using a playing component in the main interface to full-screen play the video data corresponding to said selected camera. Multi-camera video data can be displayed according to a user instruction. The multi-camera data displays data shot from different cameras, wherein the data shot from one camera is the video data that the user is watching. The user can trigger (e.g., select) video data from any one or more cameras. In response to the triggering of the video data, a request for content is communicated to the corresponding server. The video data for the camera can be received as feedback (e.g., as results associated with the request for content) from the server. The playing component in the main interface can be used in connection with analyzing the video data and to play the video data corresponding to the selected camera. The video data corresponding to the selected camera can be provided in a full-screen or a non-full screen. The video data corresponding to the selected camera can be provided in the full screen or in non-full screen based at least in part on an input (e.g., selection by a user).

In some embodiment, the request for content is determined based on the selection instruction. The request for content is generated based on the selection instruction and is communicated by the terminal to the server. The request for content based on the selection instruction in the context of a guessing or quiz game (e.g., a trivia game) can be communicated to receive guessing game option information or guessing game voice data based on selection of a related object associated with the guessing game. The corresponding request for content is generated and sent to the corresponding server. The receiving of response information as feedback (e.g., results associated with the request for content) and displaying the corresponding content in the interface according to the response information comprises: receiving guessing game status information given as feedback according to the acquisition request and using a display component in the main interface to display the guessing game status information. A related object can be used to display the guessing game information. The displayed guessing game information includes guessing game options or voice prompts. Thus, the user can trigger (e.g., select) an option to send a selection instruction to indicate the selected guessing game option or can issue guessing game voice data by using a corresponding selection instruction. Accordingly, the guessing game option information or guessing game voice data is received according to the selection instruction. The guessing game option information or guessing game voice data is used to generate an acquisition request. The request for content is sent to the corresponding server. After the server receives guessing game option information or guessing game voice data from a user, the server can total the guessing game option information and/or guessing game voice data from all users and then organize guessing game statuses. The guessing game statuses include real-time guessing game data, such as 45% guessed that Team A would win, 30% guessed that Team B would win, and 25% guessed that the teams would tie. The final outcome, such as “tie,” may be included. A user's guessing game status information is generated on the basis of guessing game statuses and the user's guessing game selection information (including guessing game option information or guessing game voice data). For example, guessing game status information includes real-time guessing game data and the user's selection, or guessing game status information includes the final outcome and the user's guessing game result. The guessing game status information is sent to the terminal (e.g., the smart television). Then, the terminal receives the guessing game status information. A display component in the main interface is used to display said guessing game status information, and the video data can continue to play during this process.

In some embodiments, receiving of response information as feedback and displaying the corresponding content in the interface according to the response information comprises: receiving screenshot sharing information as feedback according to the acquisition request and using a display component in the main interface to display the screenshot sharing information. The screenshot sharing information can comprise a Quick Response (QR) code. If the user is viewing the video data, a related object can include snapshot sharing data. The snapshot sharing data can comprise information that instructs the user to conduct screenshot sharing. After the user triggers (e.g., selects) the snapshot sharing data, a screen image is captured and a video frame for uploading can be determined in connection with the captured screen image. In some embodiments, a video frame is captured before the screen image is captured. In some embodiments, the video frame serves as a basis for generating screenshot sharing information. For example, the link address for the location at which the video frame is stored serves as screenshot sharing information. As another example, a QR code generated from this video frame is used as screenshot sharing information. The screenshot sharing information is sent to the terminal (e.g., the smart television). Upon receiving the screenshot sharing information, the terminal uses a display component to display the screenshot sharing information. Thus, a user can send the link address to chat friends or use a mobile terminal to scan the QR code in order to download the video frame for storage on another device such as the mobile terminal.

In some embodiments, if a user instruction triggered (e.g., selected) by interaction with a designated key is received while video data is not being displayed, the video-related web page obtained according to the user instruction is displayed. The video-related web page displays can comprise at least two presentation items. The presentation items can correspond to at least video frames and related objects.

When the user turns on the terminal (e.g., the smart terminal) or when video data is not being played as a result of the necessary operation having been executed in the terminal, the user can input a user instruction by triggering (e.g., selecting) the designated key, and a video frame-related page including related objects corresponding to various video data can be pushed to the user. For example, the video frame-related page including related objects corresponding to various video data can be pushed to the user in contexts in which the user is not giving a lot of attention to the terminal (e.g., the user does not have to watch the video-data with undivided attention). The related objects can be determined based on at least a piece of video data or video frame. If each user has used a user instruction to issue a request for data to determine a related object, the determined related objects corresponding to each video frame are obtained. A video frame and related objects are assembled to constitute one presentation item. For example, the video frame and the related objects can be associated with each other. As another example, the video frame and the related objects can be assembled according to a preset process. Association of the video frame and the related object can include relating the data of the related object in a manner such that the data of the related object can be identified from the video frame and the data of the related object can be linked to another app or network. One or more presentation items can be assembled according to a preset rule to make a video-related page. For example, several recently determined presentation items are selected, or the presentation item corresponding to the video data viewed by most users is selected. If the video-related page is determined to be provided as feedback (e.g., as a result to the request for data), the server provides the data for the video-related page as feedback. After the terminal receives the data for the video-related page, the terminal uses display components on the screen to display each presentation item. The terminal can display video frames and related objects, or the terminal can display video frames without displaying the related objects. The terminal can display ranking information for the related objects (e.g., ranking according to most recently viewed, or ranking according to current popularity, etc.).

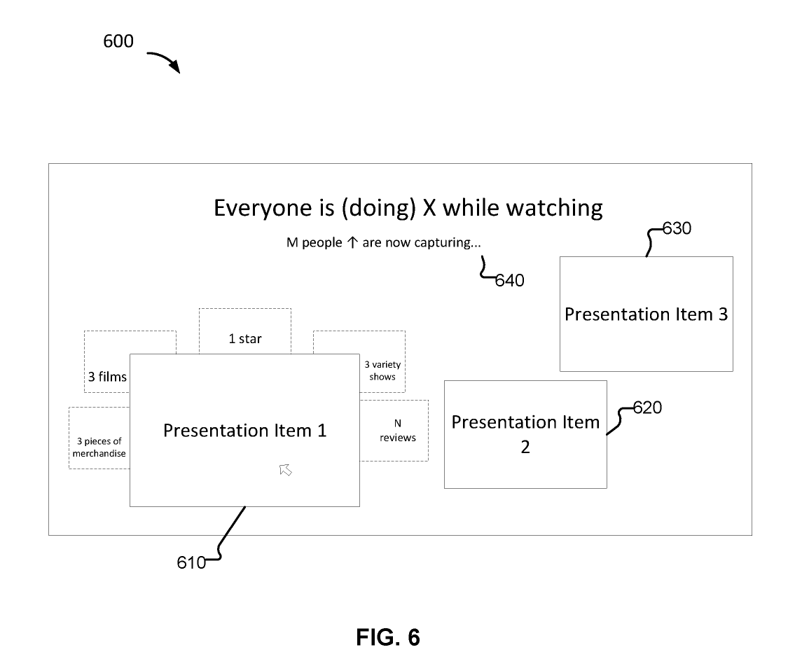

FIG. 6 is a diagram of an interface for displaying video-related pages according to various embodiments of the present application.

Referring to FIG. 6, interface 600 is provided. Interface 600 can be implemented in connection with process 200 of FIG. 2, process 400 of FIG. 4, process 700 of FIG. 7, and/or process 800 of FIG. 8. Interface 600 can be implemented by operating system 900 of FIG. 9 and/or system 1000 of FIG. 10. Interface 600 can be implemented in connection with interface 100 of FIG. 1A, interface 150 of FIG. 1B, and/or interface 300 of FIG. 3.

In an example, a designated key can be used while video data is not being played to input a user instruction.

As illustrated in FIG. 6, interface 600 displays a video-related page. The video-related page includes presentation item 1 (denoted by reference numeral 610), presentation item 2 (denoted by reference numeral 620), and presentation item 3 (denoted by reference numeral 630). The video-related page can also provide detailed information relating to the video. For example, the video-related page also includes an indication 640 that indicates the number of users currently viewing a particular video (e.g., the indication can provide “M people are capturing”). If the focal point is not on a presentation item, then just the video frame of the presentation item is displayed. For example, interface 600 includes presentation item 2 (denoted by reference numeral 620) and presentation item 3 (denoted by reference numeral 630), both of which include a corresponding video frame. Presentation item 2 and presentation item 3 can correspond to objects that do not correspond to the focal point (e.g., presentation item 2 and presentation item 3 are unselected, and a cursor is not on presentation item 2 or presentation item 3). If the focal point is on a presentation item (or if a presentation item has been selected), a video-related page provided in interface 600 includes the video frame and related objects of the corresponding presentation item. For example, interface 600 includes presentation item 1 (denoted by reference numeral 610) that includes a corresponding video frame and additional data associated with the video frame corresponding to presentation item 1 are provided. For example, if the related objects that are displayed in connection with an object being the focal point (or selected) can include related objects such as an indication of a number of related videos (e.g., interface 600 includes an indication of 3 movies), an indication of a number of related merchandise (e.g., interface 600 includes an indication of 3 pieces of merchandise), an indication of a rating associated with the video (e.g., interface 600 includes a rating of 1 star), an indication of a number of related shows (e.g., interface 600 includes an indication of 3 variety shows), and an indication of a number of reviews (e.g., interface 600 includes an indication of N reviews). In some embodiments, the related objects include information on a rating associated with the video, information on merchandise associated with the video, information on a review associated with the video, information on a star associated with the video, etc.

In some embodiments, the related objects associated with the video include video-related data, multi-camera video data, etc. The related objects can include information such as other films in which the star identified in the video has acted, and sidelights or trailers relating to the video. In response to user selection of the related object, the corresponding video frame playing time point for the related object is obtained (e.g., based on the particular frame displayed in the related object) and video data can be obtained and played back starting with the playing time point. For example, the playing component is used to start playing from the recommended time point. In some embodiments, a selection is received for the video frame on or in proximity to the display component, and the video data corresponding to the video frame is played starting from the recommended time point corresponding to the shown video frame. After presentation items in the video-related page described above are selected, the playing time point may be determined according to the snapshot; and video is played starting from this time point.

FIG. 7 is a flowchart of a method for play processing on a server side according to various embodiments of the present application.

Referring to FIG. 7, process 700 is provided. Process 700 can implement interface 100 of FIG. 1A, interface 150 of FIG. 1B, interface 300 of FIG. 3, and/or interface 600 of FIG. 6. Process 700 can be implemented in connection with process 200 of FIG. 2, process 400 of FIG. 4, and/or process 800 of FIG. 8. Process 700 can be implemented by operating system 900 of FIG. 9 and/or system 1000 of FIG. 10.

At 710, a request for data is obtained. The server obtains the request for data. For example, the server can obtain the request for data from a terminal such as, for example, a smart television. The server is connected to the terminal via one or more networks. The request for data can include a video frame (e.g., a video played at the terminal), an identifier associated with a video (e.g., a video played at the terminal), a type of data being requested, a category of data being requested, a category of a video (e.g., a video played at the terminal), a file type of data being requested, an application type corresponding to data being requested, etc. The request for data can also include a user identifier and/or a terminal identifier.

The request for data can be generated based at least in part on a video (e.g., a video being played by a terminal at a time when an instruction is obtained by the terminal). In some embodiments, the request for data is generated based at least in part on the obtained instruction and the video. The terminal can generate the request for data in response to determining that the obtained instruction was obtained during playback of the video.

In some embodiments, the request for data corresponds to a data acquisition request. For example, a data acquisition request corresponding to a request for data associated with the video (e.g., a content or one or more characteristics of the video) can be generated by the terminal. The instruction can be used in connection with determining a type of data being requested (e.g., to determine the application, or file or media type for which data associated with the video is to be requested).

At 720, video information corresponding to the request for data is determined. The video information corresponding to the request for data can be determined based at least in part on the request for data. The server can determine the video information corresponding to the request for data. The video information corresponding to the request for data can comprise a video frame. In some embodiments, the server determines the video frame corresponding to the request for data. For example, the request for data can comprise a video frame. If the request for data comprises a video frame, the server obtains the video frame from the request for data. As another example, the request for data can comprise an identifier associated with a video frame. If the request for data comprises the identifier associated with the video frame, the server determines the video frame based on the identifier comprised in the request for data. As another example, the request for data can comprise an information identifying a video corresponding to the video frame and/or identifying a video frame in the video.

At 730, one or more related objects corresponding to the request for data are determined. The server can determine one or more related objects corresponding to the request for data based on the request for data. For example, the server can determine the one or more related objects based at least in part on the determined video frame. The server can determine one or more related objects corresponding to the request for data based at least in part on whether an object matches the video frame, or whether an object matches information associated with the video frame.

In some embodiments, the server queries one or more databases for the one or more related objects. For example, the server can query the one or more databases based on the video frame and/or based on information associated with the video frame. In response to the querying of the one or more databases for an object corresponding to the video frame and/or information associated with the video frame, the one or more databases can identify or return the one or more related objects to the server. The one or more databases store mappings of objects to video frames and/or information associated with video frames.

As an example, the server analyzes the requested video frame to obtain the corresponding features, algorithm calculates the data according to the features, recommends the data most mapping the features in the database, and returns the data as a result. For example, the server identifies the star and clothes in an image, according to the star and clothes characteristics, the server obtains the most matching star introduction and news information, obtains the goods most matching clothes in the database, and returns the data to the client as a result. The one or more databases comprise a variety of related data, such as the goods of Taobao, star information, news information and so on. The mapping relation is the feature by the image analysis, and matching by recommendation algorithm and database content.

At 740, results associated with the request for data are generated. As an example, the results associated with the request for data are responsive to the request for data. In response to determining the one or more objects corresponding to the request for data, the server generates the results associated with the request for data. The results associated with the request for data can comprise at least one of the one or more related objects, information identifying at least one of the one or more related objects, and/or information associated with a location of at least one of the one or more objects.

The one or more related objects determined by the server can have various formats and be of various types. A first subset of the one or more related objects can be different types of objects than a second set of the one or more related objects. For example, one of the one or more related objects can be a text, and another of the one or more related objects can be an image. As another example, one of the one or more related objects can be obtained using a first application and another of the one or more related objects can be obtained using a second application.

At 750, results associated with the request for data are communicated. As an example, the results associated with the request for data are responsive to the request for data. The server communicates the results corresponding to the request for data to a terminal such as the terminal from which the server obtained the request for data. The terminal to which the server communicates the results corresponding to the request for data can be a smart television. The server communicates the results corresponding to the request for data over one or more networks.

In response to obtaining the request for data from the terminal, the one or more servers determine the results associated with the request for data and provide the results associated with the request for data to the terminal.

In some embodiments, the results associated with the request for data comprise two or more related objects.

According to various embodiments, each related object corresponds to one application type, and the application type corresponding to at least one related object of the one or more related objects, or at least two related objects, as applicable, differs from the application type of the currently playing video data. In some embodiments, the determining of the one or more related objects comprises using characteristic information of the video frame as a basis for matching the one or more related objects or at least two related objects, as applicable. Using the characteristic information of the video frame as a basis for matching the one or more related objects or at least two related objects, as applicable comprises: determining a characteristic information label based on the video frame, and using said label to match the one or more related objects, or at least two related objects.

After receiving a request for data, the server uses the request for data as a basis for determining the video frame corresponding to the played video data (e.g., video data being played on the terminal). For example, the server can obtain the video frame directly from the request for data or determine the video frame based on video playing and playing time or based on a video identifier and the characteristic value of the video frame. In the event that the server determines the video frame, or acquires the video frame, the server uses the video frame to match a label. For example, the server can obtain the label through recognition of the video frame. The label is label data for matching related objects. The label can correspond to information associated with a video or a video frame. In some embodiments, labels can include category labels. Examples of category labels include star category, plot category, and interaction category. A video frame can have detailed content or information as the labels. For example, the label can be the name of a star or the title of a television show or movie. In summary, labels may be used to determine the key words requiring matching labels. Then a database can be queried using the key words (e.g., labels), to match at least two related objects from the database. The server generates results associated with the request for data based on related objects, and the results associated with the request for data are communicated (e.g., given as feedback) to the terminal for presentation. Thus, a server can be used in connection with meeting user needs by providing various related objects for the consumption on a terminal such as a smart television while the terminal is playing a video.

FIG. 8 is a flowchart of a method for play processing on a server side according to various embodiments of the present application.

Referring to FIG. 8, process 800 is provided. Process 800 can implement interface 100 of FIG. 1A, interface 150 of FIG. 1B, interface 300 of FIG. 3, and/or interface 600 of FIG. 6. Process 800 can be implemented in connection with process 200 of FIG. 2, process 400 of FIG. 4, and/or process 700 of FIG. 7. Process 800 can be implemented by operating system 900 of FIG. 9 and/or system 1000 of FIG. 10.

At 805, a request for data is obtained. The server obtains the request for data. For example, the server can obtain the request for data from a terminal such as, for example, a smart television. The server is connected to the terminal via one or more networks. The request for data can include a video frame (e.g., a video played at the terminal), an identifier associated with a video (e.g., a video played at the terminal), a type of data being requested, a category of data being requested, a category of a video (e.g., a video played at the terminal), a file type of data being requested, an application type corresponding to data being requested, etc. The request for data can also include a user identifier and/or a terminal identifier.

The request for data can be generated based at least in part on a video (e.g., a video being played by a terminal at a time when an instruction is obtained by the terminal). In some embodiments, the request for data is generated based at least in part on the obtained instruction and the video. The terminal can generate the request for data in response to determining that the obtained instruction was obtained during playback of the video.

In some embodiments, the request for data corresponds to a data acquisition request. For example, a data acquisition request corresponding to a request for data associated with the video (e.g., a content or one or more characteristics of the video) can be generated by the terminal. The instruction can be used in connection with determining a type of data being requested (e.g., to determine the application, or file or media type for which data associated with the video is to be requested).

In some embodiments, the request for data comprises information corresponding to a prompt. For example, the request for data comprises information corresponding to a prompt that was provided at a terminal. The prompt provided at the terminal can correspond to a prompt or message that was presented to a user and in response to which the user invoked the terminal to communicate the request for data. The information corresponding to the prompt can comprise a prompt parameter. The prompt parameter can include information associated with the prompt (e.g., a type of prompt, a type of application associated with the prompt, etc.). In some embodiments, the request for data comprises a video frame and a prompt parameter, or information from which the video frame and the prompt parameter can be determined.

At 810, video information corresponding to the request for data is determined. The video information corresponding to the request for data can be determined based at least in part on the request for data. The server can determine the video information corresponding to the request for data. The video information corresponding to the request for data can comprise a video frame. In some embodiments, the server determines the video frame corresponding to the request for data. For example, the request for data can comprise a video frame. If the request for data comprises a video frame, the server obtains the video frame from the request for data. As another example, the request for data can comprise an identifier associated with a video frame. If the request for data comprises the identifier associated with the video frame, the server determines the video frame based on the identifier comprised in the request for data. As another example, the request for data can comprise information identifying a video corresponding to the video frame and/or identifying a video frame in the video.

In some embodiments, determining the video information corresponding to the request for data comprises determining a video frame corresponding to the request for data.

At 815, a playing time of a video and/or a characteristic value corresponding to the video is determined. The server determines the playing time of the video and/or the characteristic value corresponding to the video. For example, the server can determine the playing time of the video and/or the characteristic value corresponding to the video based at least in part on the request for data. In some embodiments, the server determines the playing time of the video and/or a characteristic value based at least in part on the request for data. The characteristic value corresponding to the video can correspond to a characteristic value corresponding to a video frame comprised in, or identified based on, the request for data.

At 820, it is determined whether the video information comprises characteristic information. The server determines the video information comprises characteristic information. The server can determine whether the video information comprises characteristic information based at least in part on the playing time of the video and/or characteristic value. In some embodiments, the server determines whether the video information comprises characteristic information based on whether the video information comprises recognized characteristic information. Recognized characteristic information can correspond to text-based characteristic information. Recognized characteristic information can correspond to characteristic information that can be obtained or extracted without further processing such as image processing. Recognized characteristic information can correspond to characteristic information that was obtained in connection with a previous query relating to the same video frame.

In the event that the video information is determined to comprise characteristic information at 820, process 800 proceeds to 825 at which characteristic information and/or a label corresponding to the characteristic information is obtained. Process 800 then proceeds to 835. The server obtains the characteristic information and a label corresponding to the characteristic information. The characteristic information and/or the label corresponding to the characteristic information can be metadata stored in association with the video information (e.g., the video frame).

In the event that the video information is determined to not comprise characteristic information at 820, process 800 proceeds to 830 at which image recognition is performed on the video information and characteristic information is obtained. Process 800 then proceeds to 835. The server can process the video information in connection with obtaining the characteristic information. An example of such processing of the video information is an image processing. Image processing can comprise image recognition, text recognition (e.g., Optical Character Recognition (OCR) processing), etc. The server can use other processes and techniques for obtaining the characteristic information from the video information. The server obtains the characteristic information based on the processing of the video information, and the server uses the characteristic information in connection with matching or determining labels. For example, the server can use the characteristic information in connection with determining the labels associated with the video information.

In some embodiments, the server performs the image processing on the video frame comprised in the video information. The server can process the image corresponding to the video frame and thereafter extract the characteristic information associated with the video frame.

At 835, one or more data sets are queried to determine one or more related objects. The server can determine one or more related objects corresponding to the request for data based on the request for data. For example, the server can determine the one or more related objects based at least in part on the determined video frame. The server can determine one or more related objects corresponding to the request for data based at least in part on whether an object matches the video frame, or whether an object matches information associated with the video frame. As another example, the server determines the one or more related objects based at least in part on the characteristic information obtained from the video frame. As another example, the server determines the one or more related objects based at least in part on the labels obtained from the video frame.

In some embodiments, the server queries one or more databases for the one or more related objects. For example, the server can query the one or databases based on the video frame and/or based on information associated with the video frame (e.g., the characteristic information, a label, etc.). In response to the querying of the one or more databases for an object corresponding to the video frame and/or information associated with the video frame, the one or more databases can identify or return the one or more related objects to the server. The one or more databases store mappings of objects to video frames and/or information associated with video frames.

In some embodiments, the playing time point or characteristic value corresponding to the video frame can be obtained. The server analyzes the playing time point or characteristic value to determine whether the corresponding video frame has already recognized characteristic information. If a previous query was processed in connection with the time point associated with the request for data, or if the time or corresponding web frame was pre-analyzed, the video data corresponding to the playing time point will have characteristic information associated therewith. The characteristic information and the label corresponding to the characteristic information may be obtained directly from a database. If the video data corresponding to the playing time point does not have characteristic information, the video frame can be processed using image recognition to obtain characteristic information. In some embodiments, the characteristic information includes: character characteristic information and content characteristic information. Character characteristic information includes various kinds of video character information, such as which star the character is and who the character is in the show. Content characteristic information includes the plot corresponding to the scene in the show, the location of the scene, and other such information. Various image recognition methods may be used to conduct recognition. For example, character characteristic information can be determined through face recognition, and content characteristic information can be determined through a method such as preset critical points. Thus, characteristic information is determined according to recognized characters, plots, and so on. Then the characteristic information is used as a query word to query one or more databases and in connection with determining at least one matched related objected.

In some embodiments, the one or more related objects are determined based at least in part on a prompt parameter. For example, if a prompt parameter is comprised in the request for data, the prompt parameter serves as a basis for determining the corresponding related object. The related object may also be matched (e.g., searched) in combination with the video data, the playing time point, and other information. For example, application information corresponding to the prompt parameter is determined, or interaction information is matched in combination with video and other data.

In some embodiments, browsing tracks collected according to a user identifier within a preset period of time is used as a basis for determining user behavior information. For example, a user might be registered with a server. Thus, collecting user behavior information according to user account information or collecting user behavior information according to the user's IP address or terminal identifier is possible. A label can be matched based on the user behavior information.

In some embodiments, one or more data sets are used to determine related objects. The data sets can be data sources such as databases and data lists, or the data sets correspond to index information sets for data sources. Thus, data sets can be looked up using labels and characteristic information so as to determine related objects. A data source can store content data or index data for various kinds of related objects. The content data or index data can originate from data on the platform on which a main server is located, or the content data or index data originates from the web and thus can be obtained from other business platforms. The content data or index data can be acquired through interfaces provided by the business platforms. For example, video data of a related object of the video type can be stored in a database of a platform corresponding to a main server, or the video data of a related object can originate from, or be stored at, an external video website. In the case of third party application data, the data can be sent back from an interface provided by the business platform based on a third party app. For example, key information and other information can serve as the key words for searches through the interface; information is received as feedback from the third party application business platform. This information can be added to a database. Or the third party application business platform could be regarded as one of the data sources, and the related objects and data acquisition results could be determined on the basis of the information that is sent back.

At 840, information associated with the one or more related objects is obtained. The server obtains information associated with the one or more related objects based at least in part on the query of the one or more data sets. For example, in response to determining the one or more related objects, the server obtains information associated with the one or more related objects. The server can obtain the information associated with the one or more related objects from the one or more databases that were queried, or the server can obtain the information associated with the one or more related objects from another database or data set. For example, the server can obtain an identifier(s) associated with the one or more related objects in connection with determining the one or more related objects based on the query, and the server can obtain information associated with the one or more related objects based at least in part on the corresponding identifier(s).

In some embodiments, the information associated with the one or more related objects corresponds to characteristic information on the video data. For example, the information relating to characteristic information on the video data acquired from within the said one or more related objects includes various kinds of information, such as display information, descriptive information, and information overviews on related objects of corresponding types. The characteristic information can also include selectable link addresses (e.g., a hyperlink), sources, etc. the said the one or more related objects and information relating to characteristic information on the video data and corresponding to the related objects are used to generate the results associated with the request for data.

At 845, results associated with the request for data are generated. As an example, the results associated with the request for data are responsive to the request for data. In response to determining the one or more objects corresponding to the request for data, the server generates the results associated with the request for data. The results associated with the request for data can comprise at least one of the one or more related objects, information identifying at least one of the one or more related objects, and/or information associated with a location of at least one of the one or more objects.

The one or more related objects determined by the server can have various formats and be of various types. A first subset of the one or more related objects can be different types of objects than a second set of the one or more related objects. For example, one of the one or more related objects can be a text, and another of the one or more related objects can be an image. As another example, one of the one or more related objects can be obtained using a first application and another of the one or more related objects can be obtained using a second application.

At 850, results associated with the request for data are communicated. As an example, the results associated with the request for data are responsive to the request for data. The server communicates the results corresponding to the request for data to a terminal such as the terminal from which the server obtained the request for data. The terminal to which the server communicates the results corresponding to the request for data can be a smart television. The server communicates the results corresponding to the request for data over one or more networks.

In response to obtaining the request for data from the terminal, the one or more servers determine the results associated with the request for data and provide the results associated with the request for data to the terminal.

In some embodiments, the results associated with the request for data comprise two or more related objects.

At 855, a request for content is obtained. The server obtains the request for data. For example, the server can obtain the request for data from a terminal such as, for example, a smart television. The server is connected to the terminal via one or more networks. In response to determining that a related object is selected, the terminal generates a request for content and communicates the request for content. The request for content corresponds to a request for content associated with the selected related object. The request for content can comprise one or more of an identifier associated with the selected related object, information associated with the selected related object, an identifier associated with the video data provided (e.g., video data 310 of FIG. 3), a video frame associated with the video data provided, a time point indicating a time (e.g., in relation to the video data provided) at which the related object is selected, a type of content being requested, a type of application associated with the related object, etc.

In some embodiments, the request for content corresponds to a web page request. For example, the request for content can correspond to a request for content relating to the related object to be provided to a web page.

At 860, results associated with the request for content are obtained. The server obtains the results associated with the request for content based at least in part on the request for content. In some embodiments, the server obtains the results associated with the request for content based at least in part on querying one or more databases or other data sets for content. The request for content can include an identifier associated with a related object for which content is being requested. The server can use the identifier in connection with querying the one or more databases or other data sets.

After receiving a request for data, other related objects can be obtained or identified according to a matching rule. The matching rule can be set according to actual needs. After the server communicates the related objects or the results associated with the request for data, the recommendation information for some related objects is still provided by the main server, but the recommendation information for other related objects may be provided by other business servers. In the case of recommendation content that is to be provided by the main server, the main server can receive a request for content sent by the terminal (e.g., the smart television). The recommendation content (e.g., information associated with the request for content such as information that is responsive to the request for content) is determined according to the request for content, and the recommendation content is thereupon used to generate the results associated with the request for content. The results associated with the request for content are then sent to the terminal. For example, in the case of interaction information such as for a guessing game, the corresponding interaction status and interaction result can be sent as results associated with the request for content that are communicated back to the terminal (e.g., to the user thereof).

At 865, results associated with the request for content are communicated. As an example, the results associated with the request for content are responsive to the request for content. The server communicates the results corresponding to the request for content to a terminal such as the terminal from which the server obtained the request for content. The terminal to which the server communicates the results corresponding to the request for content can be a smart television. The server communicates the results corresponding to the request for content over one or more networks.

In summary, with help from a server, various related objects (such as video snapshot related objects, request parameter related objects, and related objects according to another current rule) can be matched when the user makes a request. Thus, the user may acquire various information while viewing the video and execute various necessary operations to meet the user's various needs.

According to various embodiments, a display processing method is provided. The display processing method comprises: displaying a video frame of video data in an interface and displaying a presenting interface for at least one related object of at least two related objects. The at least two related objects are determined according to characteristic information corresponding to all or part of the video frame. The information presented by the presenting interface at least comprises: information relating to characteristic information on the video data or an information overview relating to the characteristic information on the video data. Each related object can correspond to one application type, and the application type corresponding to at least one of said at least two related objects differs from the application type of said video data. In some embodiments, each related object can correspond to one or more application types.

The video frame displaying video data in the interface and the presenting interface displaying at least one related object of the at least two related objects comprise: using a playing component in the interface to play video data and using at least one display component to display the presenting interface for a related object. As an example, one display component corresponds to one related object. The display component has an expanded mode and a retracted mode. If the focal point is positioned over the display component, the display component uses the presentation mode to display the display information and descriptive information relating to the characteristic information on the video data; if the focal point is not positioned over the display component, the display component uses the retracted mode to display the information overview relating to the characteristic information on the video data.

In some embodiments, a user instruction triggered by a designated key is received while video data is not being displayed. The user instruction serves as a basis for acquiring return data for acquiring a video-related page. The video frame displaying video data in the interface and the presenting interface displaying at least one related object of the at least two related objects comprises: using the display component in the interface, in accordance with the data of the video-related page, to display the video frame of the video data and an information overview for the related object corresponding to the video frame. With regard to triggering (e.g., selecting) the video frame in the video-related page, the corresponding video data may begin playing from the playing time point corresponding to the video frame. The playing component may be used for full-screen playing of the video data, or the playing component within the interface may be used to play the video data. Moreover, at least one display component may be used to display a presenting interface for a related object.

In some embodiments, a playing component is used for full-screen playing of video data. An instruction (e.g., a user instruction) can be received (e.g., by the terminal). The playing component is used within the interface to play the video data, and at least one display component is used to display a presenting interface for a related object. Based at least in part on the user instruction and a display template, the playing component can be switched to non-full screen mode in the interface and the playing component can be used to play the video data in the primary position and use display components to display the presenting interfaces for related objects in at least one auxiliary position.

The user instruction can be triggered (e.g., selected) by a designated key. The designated key can provide on a remote control device, a mobile terminal, a touch screen of the terminal, etc.

In some embodiments, an instruction (e.g., a trigger instruction) is received for the video frame in the display component, and the video data corresponding to the video frame is played starting from the playing time point corresponding to the shown video frame. A display template serves as a basis for playing the video data at a primary position of the interface and for displaying the presenting interfaces of the related objects at various auxiliary positions. For example, a display template can be set up in advance for the layout of video data and related objects. The display template includes one primary position and at least one auxiliary position. The video data can be played at the primary position. For example, a playing component at the primary position plays video data. Each auxiliary position can correspond to one playing component. Thus, presenting interfaces of related objects can be displayed at the auxiliary positions. Based on an input (e.g., an input to a designated key), video can be switched from full-screen playing to primary-position playing or the video can be switched from primary-position playing to full-screen playing. The playing component can control the size and position of the video playing interface. One main interface can display two or more windows playing video data and displaying related objects. Moreover, the presenting interfaces of different related objects may be switched between the various auxiliary positions. It is possible to switch auxiliary positions according to the user instruction and to switch according to user habits, etc.

An embodiment of the present application could be applied to various business scenarios. One business scenario is as follows: as shown in FIG. 1A, the user uses a terminal (e.g., a smart television). The terminal uses a playing component to full-screen play video data, and the playing component displays a prompt message. If the user finds the prompt message interesting or is interested in some of the content in the video, the user can input an input to the terminal (e.g., input an instruction such as a user instruction through a designated key). The user instruction can serve as a basis for generating a data acquisition request sent to a server. As an example, after the server sends back related objects, the interface 300 (e.g., a user interface provided by the terminal) as shown in FIG. 3 is displayed. The interface can include video data played after the playing component has exited from full-screen mode and various related objects displayed using the display components. For example, it includes Video-related Information 1, Evaluative Information 2, Multi-Camera Video Data 3, Snapshot Sharing Data 4, Interactive Task Information 5, Guessing Game Information 6, Weather Application Information 7, and Video-related Object Information 8, as shown in FIG. 8. The display components have a retracted mode and an expanded mode. If the focal point is not positioned over a display component (or within a preset proximity or distance to the display component), the display component is provided in retracted mode and merely presents display information. If the focal point is positioned over a display component (or within the preset proximity or distance to the display component), the display component is provided in expanded mode and can present display information and descriptive information. For example, Video-related Information 1 having the focal point there over is provided in expanded mode. In response to triggering (e.g., selecting) any display component, the user can obtain recommendation content for the related object on that component. For example, the video data is direct-broadcast video of a concert. For example, after the Multi-Camera Video Data 3 is triggered (e.g., selected), the multi-camera recommendation content can be displayed by the user interface as shown in FIG. 5. The video data can correspond to the video data from one of the cameras, and the user may select video data from another one of the cameras. As another example, in response to triggering (e.g., selecting) Snapshot Sharing Data 4, a video image can be captured and uploaded, or a QR code determined on the basis of a video frame uploaded during a previous viewing request can be obtained and the QR code can be displayed in the display component corresponding to Snapshot Sharing Data 4. In response to triggering (e.g., selecting) to enter full-screen playing mode and triggering (e.g., selecting) to display the QR code on the screen, the user can obtain the video frame based on the QR code.

As an example, with reference to FIG. 6, while the terminal is not playing video data, a viewing request (e.g., triggered by input to a designated key) is received; a video related page is obtained from a server and displayed. In response, the video-related page, such as the video-related page as shown in FIG. 6, can be displayed. The video-related page includes presentation items 1 through 3. The video-related page also displays the number of currently viewing users, e.g., “M people are now capturing.” If the focal point is not on a presentation item, then just the video frame of the presentation item may be displayed, as is the case with presentation item 2 or 3. If the focal point is on a presentation item, the video frame and related objects of the presentation item can be displayed. For example, FIG. 6 illustrates a focal point being on presentation item 1. Its related objects that can be displayed include: 3 films, 3 pieces of merchandise, 1 star, 3 variety shows, and N reviews. After presentation item 1 is triggered (e.g., selected), the playing component can be used to full-screen display the video data corresponding to this presentation item. The video data starts playing from the snapshot time point as illustrated in FIG. 1A. At the same time that the playing component is used to play video, display components can be used to display related objects as illustrated in FIG. 1B. The user may subsequently trigger a display component to display corresponding recommendation content.

When a user is using a smart television, most of the time is spent viewing. According to various embodiments, during the viewing process, the user is provided other information in real time as a film is being presented. Such providing of other information improves the TV's full-screen presenting layout. Various embodiments ensure that user viewing remains unaffected by the providing of other information and provides real-time recognition of information associated with the film.

In addition, the user has a need to use the film content to search for other information relating to the film. Various embodiments implement image recognition technology to capture valid, film-related information and, in film and television information recommendations, use recognition technology to automatically perform recognition on captured films. Using the film content as an input, various embodiments provide recommendations to the user and meet the various needs of the user.

Various embodiments do not restrict changes in moving cursor color, transparency, or shape. Characteristics or properties of a cursor can be set according to actual need or preference of a user. Moreover, no limits are imposed on changes in the visual effects of related objects displayed by display components in the user interface.

Please note that all the method embodiments have been presented as a series of a combination of actions in order to simplify the description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the description are all preferred embodiments. The actions that the embodiments described herein involve are not required by embodiments of the present application.

According to various embodiments, the related objects can comprise at least one of the following categories: viewing enhancement category, chat category, interaction category, business category, and application category. Related objects in the viewing enhancement category can include at least one of the following: related video data, related audio data, evaluative information, video descriptive information, multi-camera video data, and video-related object information. Related objects in the chat category can include at least one of the following: chat content data, snapshot sharing data, and video sharing data. Related objects in the interaction category can include at least one of the following: guessing game information, “bullet screen” data, interactive object information, and interactive task information. Related objects in the application category can include at least one of the following: exercise application information, game application information, timer alert information, weather application information, and information application information.

According to various embodiments, characteristic information comprises: character characteristic information and content characteristic information. The characteristic information can include information for at least one of the following: viewing enhancement category, chat category, interaction category, business category, and application category. Related objects in the viewing enhancement category can include at least one of the following: related video data, related audio data, evaluative information, video descriptive information, multi-camera video data, and video-related object information. Related objects in the chat category can include at least one of the following: chat content data, snapshot sharing data, and video sharing data. Related objects in the interaction category can include at least one of the following: guessing game information, voice “bullet screen” data, interactive object information, and interactive task information. Related objects in the application category can include at least one of the following: exercise application information, game application information, timer alert information, weather application information, and information application information.

According to various embodiments, a terminal such as a smart television comprises a processor, a communication component, and a display device. The communication component can be coupled to said processor and receives a user instruction during the video data-playing process. The communication component sends the request for data, wherein the request for data comprises all or part of the video frame corresponding to the video data. The communication component receives results associated with the request for data, and the results associated with the request for data can comprise at least two related objects, wherein the at least two related objects are determined according to characteristic information corresponding to all or part of said video frame, each related object corresponding to one application type, the application type corresponding to at least one of said at least two related objects differing from the application type of the currently playing video data. The information presented by the presenting interface at least comprises: information relating to the characteristic information on the video data or an information overview relating to the characteristic information on the video data.

According to various embodiments, a server comprises: a processor and a communication component. The communication component can be coupled to the processor and receives a request for data and communicates results associated with the request for data as feedback. The processor uses the request for data as a basis for determining a video frame corresponding to the played video data and uses the video frame characteristic information as a basis for matching at least two related objects, wherein each related object corresponds to one application type, and the application type corresponding to at least one related object of said at least two related objects differs from the application type of the currently playing video data.

FIG. 9 is a structural diagram of an operating system according to various embodiments of the present application.

Referring to FIG. 9, operating system 900 is provided. Operating system 900 can be implemented by a terminal and/or a server. Operating system 900 can implement interface 100 of FIG. 1A, interface 150 of FIG. 1B, interface 300 of FIG. 3, interface 500 of FIG. 5, and/or interface 600 of FIG. 6. Operating system 900 can be used in connection with implementing at least part of process 200 of FIG. 2, process 400 of FIG. 4, process 700 of FIG. 7, and/or process 800 of FIG. 8. Operating system 900 can be implemented by system 1000 of FIG. 10.

Operating system 900 comprises a displaying module 910, a communication module 920, and a processing module 930.

The displaying module 910 plays video data. In an interface comprising the video data, a presenting interface is displayed for at least one related object of the at least two related objects. The information presented by the presenting interface at least comprises: information relating to the characteristic information on the video data or an information overview relating to the characteristic information on said video data.

The communication module 920 is configured to receive an instruction (e.g., a user instruction) during the video data-playing process, and send the request for data, wherein the request for data can comprise all or part of the video frame corresponding to the video data. The communication module 920 is further configured to receive results associated with the request for data, wherein the results associated with the request for data comprise at least two related objects. The at least two related objects can be determined according to characteristic information corresponding to all or part of said video frame, each related object corresponding to one application type, the app type corresponding to at least one of said at least two related objects differing from the application type of the currently playing video data.

Processing module 930 is configured to generate a request for data based on an instruction input to the terminal (e.g., the user instruction).

FIG. 10 is a functional diagram of a computer system for play processing according to various embodiments of the present disclosure.

Referring to FIG. 10, system 1000 is provided. System 1000 can be implemented by a terminal and/or a server. System 1000 can implement interface 100 of FIG. 1A, interface 150 of FIG. 1B, interface 300 of FIG. 3, interface 500 of FIG. 5, and/or interface 600 of FIG. 6. System 1000 can be used in connection with implementing at least part of process 200 of FIG. 2, process 400 of FIG. 4, process 700 of FIG. 7, and/or process 800 of FIG. 8. System 1000 can implement operating system 900 of FIG. 9.

Computer system 1000, which includes various subsystems as described below, includes at least one microprocessor subsystem (also referred to as a processor or a central processing unit (CPU)) 1000. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data, and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown). The memory can be a non-transitory computer-readable storage medium.

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storage device 1012 and fixed mass storage 1020 generally store additional programming instructions, data, and the like that typically are not in active use by the processor 1002. It will be appreciated that the information retained within mass storage device 1012 and fixed mass storage 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

It should be understood that the devices and methods that are disclosed in the several embodiments provided above can be realized in other ways. For example, the device embodiment described above is merely illustrative. For example, the delineation of units is merely a delineation according to local function. The delineation can take a different form during actual implementation.

A module described herein can also be referred to as a unit.

The units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

Furthermore, the functional units in the various embodiments of the present invention can be integrated into one processing unit, or each unit can have an independent physical existence, or two or more units can be integrated into a single unit. The aforesaid integrated units can take the form of hardware, or they can take the form of hardware combined with software function units.

The units described above in which the software function units are integrated can be stored in a computer-readable storage medium. The software function units described above are stored in a storage medium and include a number of commands whose purpose is to cause a piece of computer equipment (which can be a personal computer, a server, or network computer) or a processor to execute some of the steps in the method described in the various embodiments of the present invention. The storage medium described above encompasses: USB flash drive, mobile hard drive, read-only memory (ROM), random access memory (RAM), magnetic disk, or optical disk, or various other media that can store program code.

Embodiments relating to operating system 900 and system 1000 are similar to the method embodiments described herein; accordingly, embodiments relating to operating system 900 and system 1000 are described in simpler terms. Refer to the corresponding section in a method embodiment as necessary.

Each of the embodiments contained in this description is described in a progressive manner, the explanation of each embodiment focuses on areas of difference from the other embodiments, and the descriptions thereof may be mutually referenced for portions of each embodiment that are identical or similar.

The embodiments of the present application are described with reference to flowcharts and/or block diagrams based on methods, terminal devices (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer instructions. These computer program instructions can be provided to the processors of general-purpose computers, specialized computers, embedded processor devices, or other programmable data-processing terminals to produce a machine. The instructions executed by the processors of the computers or other programmable data-processing terminal devices consequently give rise to means for implementing the functions specified in one or more processes in the flowcharts and/or one or more blocks in the block diagrams.

These computer program instructions can also be stored in computer-readable memory that can guide the computers or other programmable data-processing terminal devices to operate in a specific manner. As a result, the instructions stored in the computer-readable memory give rise to products including instruction means. These instruction means implement the functions specified in one or more processes in the flowcharts and/or one or more blocks in the block diagrams.

These computer program instructions can also be loaded onto computers or other programmable data-processing terminal devices and made to execute a series of steps on the computers or other programmable data-processing terminal devices so as to give rise to computer-implemented processing. The instructions executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise said elements.

The play processing method and means and display processing method and means provided by the present application have been described in detail above. This document has employed specific examples to expound the principles and embodiments of the present application. The above embodiment explanations are only meant to aid in comprehension of the methods of the present application and of its core concepts. Moreover, a person with ordinary skill in the art would, on the basis of the concepts of the present application, be able to make modifications to specific applications and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining an instruction during playback of video data;
generating a request for data based at least in part on the instruction, wherein the request for data comprises information associated with the video data;
obtaining results associated with the request for data, wherein the results associated with the request for data comprise one or more related objects relating to the video data, the one or more related objects corresponding to one or more respective application types, at least one of the one or more application types corresponding to at least one of the one or more related objects being different from an application type of the video data; and
providing at least one of the one or more related objects concurrently with the video data.

2. The method of claim 1, wherein the information associated with the video data that is comprised in the request for data comprises at least part of a video frame corresponding to the video data.

3. The method of claim 1, wherein the one or more related objects are determined according to characteristic information corresponding to at least part of a video frame corresponding to the video data.

4. The method of claim 1, wherein the providing of the at least one of the one or more related objects comprises displaying the at least one related object in one or more corresponding presenting interfaces within an interface that comprises a display of the video data.

5. The method of claim 1, wherein the at least one of the one or more related objects is provided in one or more corresponding presenting interfaces, and the one or more presenting interfaces respectively comprise information relating to characteristic information for the video data or an information overview relating to the characteristic information for the video data.

6. The method of claim 1, further comprising:
determining a playing time point corresponding to a time at which the instruction is obtained; and
obtaining a video frame corresponding to the video data, wherein the video frame is obtained based at least in part on the playing time point.

7. The method of claim 6, wherein the obtaining of the video frame corresponding to the video data comprises extracting the video frame from the video data.

8. The method of claim 1, wherein the obtaining of the instruction comprises:
receiving a user instruction while a playing component provides a full-screen play of the video data.

9. The method of claim 1, wherein the video data is displayed in a playing component, the playing component providing a full-screen play of the video data when the instruction is obtained, and the providing the at least one of the one or more related objects concurrently with the video data comprises:
switching the playing component to provide a non-full screen playing of the video data; and
providing at least one display component to display a presenting interface for the at least one of the one or more related objects, one of the at least one display component corresponding to one of the one or more related objects.

10. The method of claim 9, further comprising:
in response to a focal point being positioned over a first display component of the at least one display component, displaying display information and descriptive information relating to characteristic information for the video data.

11. The method of claim 10, further comprising:
in response to the focal point not being positioned over the first display component, displaying an information overview relating to the characteristic information for video data.

12. The method of claim 1, wherein at least one of the one or more related objects is associated with one or more of: a viewing enhancement category, a chat category, an interaction category, a business category, and an application category.

13. The method of claim 1, further comprising:
receiving a selection of a first related object of the at least one related object that is provided;
generating a request for content based at least in part on the selection;
communicating the request for content;
obtaining results associated with the request for content; and
displaying corresponding content based at least in part on the results associated with the request for content.

14. The method of claim 13, wherein the displaying the corresponding content based at least in part on the results associated with the request for content includes:
playing video data corresponding to results associated with the request for content in a playing component; or
displaying the content corresponding to the results associated with the request for content in a presenting interface.

15. The method of claim 13, wherein the displaying corresponding content based at least in part on the results associated with the request for content comprises:
displaying playback of video data corresponding to a selected camera in a full-screen mode in response to selection of the video data corresponding to the selected camera from among multi-camera video data.

16. The method of claim 1, further comprising:
displaying a prompt message during the playback of the video data,
wherein the generating the request for data based at least in part on the instruction comprises:
determining a prompt parameter corresponding to the prompt message based at least in part on the instruction, wherein the instruction corresponds to a user instruction that is input by a user; and
adding the prompt parameter to the request for data, wherein the results associated with the request for data comprise related objects corresponding to the prompt parameter.

17. The method as described in claim 1, further comprising:
in response to the instruction being received while video data is not being displayed, obtaining a video-related page based at least in part on the instruction and displaying the video-related page, wherein the video-related page provides at least two presentation items, the presentation items comprising video frames and related objects.

18. The method of claim 1, wherein:
the providing of the at least one of the one or more related objects comprises displaying the at least one related object in one or more corresponding presenting interfaces within an interface that comprises the video data; and
the video data is provided at a primary position of the interface and the presenting interfaces of related objects are displayed at various auxiliary positions based at least in part on a display interface.

19. The method of claim 1, wherein the request for data comprises one or more of a video frame, a video frame playing time point, and a video frame characteristic value.

20. A device, comprising:
one or more processors configured to:
obtain an instruction during playback of video data;
generate a request for data based at least in part on the instruction, wherein the request for data comprises information associated with the video data;
obtain results associated with the request for data, wherein the results associated with the request for data comprise one or more related objects relating to the video data, the one or more related objects correspond to one or more respective application types, at least one of the one or more application types corresponding to at least one of the one or more related objects being different from an application type of the video data; and
provide at least one of the one or more related objects concurrently with the video data; and
one or more memories coupled to the one or more processors, configured to provide the one or more processors with instructions.

21. A computer program product, the computer program product being embodied in a non-transitory computer readable storage medium and comprising computer instructions for:
obtaining an instruction during playback of video data;
generating a request for data based at least in part on the instruction, wherein the request for data comprises information associated with the video data;
obtaining results associated with the request for data, wherein the results associated with the request for data comprise one or more related objects relating to the video data, the one or more related objects corresponding to one or more respective application types, at least one of the one or more application types corresponding to at least one of the one or more related objects being different from an application type of the video data; and
providing at least one of the one or more related objects concurrently with the video data.

22. A method, comprising:
receiving a request for data;
determining a video frame corresponding to played video data based at least in part on the request for data;
determining one or more related objects based at least in part on the video frame, wherein the one or more related objects correspond to one or more respective application types, at least one of the one or more application types corresponding to at least one related object of the one or more related objects being different from an application type of a currently playing video data relating to the request for data;
generating results associated with the request for data based at least in part on the one or more related objects; and
communicating the results associated with the request for data to a terminal.

23. The method of claim 22, wherein determining the one or more related objects comprises:
determining a characteristic information label based at least in part on the video frame; and
identifying the one or more related objects based at least in part on the characteristic information label.

24. The method of claim 23, wherein the determining the characteristic information label based on the video frame comprises:
performing an image recognition on the video frame to obtain characteristic information; and
determining the characteristic information label corresponding to the characteristic information.

25. The method of claim 24, further comprising:
before performing the image recognition on the video frame to acquire characteristic information;
determining a playing time point or a characteristic value corresponding to the video frame; and
in response to determining the playing time point or the characteristic value corresponding to already recognized characteristic information belonging to the video frame, obtaining the characteristic information from storage.

26. The method of claim 22, further comprising:
obtaining the one or more related objects based on a prompt parameter that is comprised in the request for data.

27. The method of claim 22, further comprising:
obtaining a request for content;
determining related object content based at least in part on the request for content; and
generating results associated with the request for content based at least in part on the related object content.

28. A device, comprising:
one or more processors configured to:
receive a request for data;
determine a video frame corresponding to played video data based at least in part on the request for data;
determine one or more related objects based at least in part on the video frame, wherein the one or more related objects correspond to one or more respective application types, at least one of the one or more application types corresponding to at least one related object of the one or more related objects being different from an application type of a currently playing video data relating to the request for data;
generate results associated with the request for data based at least in part on the one or more related objects; and
communicate the results associated with the request for data to a terminal; and
one or more memories coupled to the one or more processors, configured to provide the one or more processors with instructions.

29. A computer program product, the computer program product being embodied in a non-transitory computer readable storage medium and comprising computer instructions for:
receiving a request for data;
determining a video frame corresponding to played video data based at least in part on the request for data;
determining one or more related objects based at least in part on the video frame, wherein the one or more related objects correspond to one or more respective application types, at least one of the one or more application types corresponding to at least one related object of the one or more related objects being different from an application type of a currently playing video data relating to the request for data;
generating results associated with the request for data based at least in part on the one or more related objects; and
communicating the results associated with the request for data to a terminal.
